(19) United States
(12) Patent Application Publication
(10) Pub. No.: US 2019/0073029 A1
(43) Pub. Date: Mar. 7, 2019

(54) SYSTEM AND METHOD FOR RECEIVING USER COMMANDS VIA CONTACTLESS USER INTERFACE

(71) Applicant: NEURALAND LLC, Moscow (RU)

(72) Inventors: Denis Borisovich FILATOV, Moscow (RU); Dmitrii Mikhailovich VELIKANOV, Cheboksary (RU)

(21) Appl. No.: 16/104,266

(22) Filed: Aug. 17, 2018

(30) Foreign Application Priority Data
Aug. 18, 2017 (RU) 2017129475

(51) Int. Cl. G06F 3/01; G06F 3/0484

(52) U.S. Cl. CPC G06F 3/015; G06F 3/167; G06F 3/013; G06F 3/0484

(57) ABSTRACT

The present technical solution relates to methods and systems for contactless user interfaces and can be used to control personal computers or GUI-based electronic devices by means of a brain-computer interface. A method for contactless user interface, the method executable by a computer, the method comprising: obtaining at least two GUI sub-areas of arbitrary shape and size from a third-party application; displaying at least one visual stimulus corresponding to at least one sub-area mentioned above to the user; identifying at least one target stimulus corresponding to the sub-area, with which the user wants to interact; obtaining a sub-area corresponding to the target stimulus; notifying the third-party application that said sub-area has been identified.

### FIELD OF THE TECHNOLOGY

The present technical solution relates to methods and systems for contactless user interfaces and can be used to control personal computers or GUI-based electronic devices by means of a brain-computer interface.

### BACKGROUND

A brain-computer interface, or BCI, is a system for exchanging information between a human brain and an electronic computing device, such as a computer. In fact, such system may operate in a way that the user of a computing device doesn't need to perform any manual operations, since the command the user has selected (by thinking about it) can be recognized by means of at least one device, such as a BCI, or at least a part thereof based on the user's brain activity. Non-invasive BCIs are based on interaction with the user through provision of stimuli and on-line analysis of electroencephalographic (EEG) data. In exemplary cases, EEG data are not saved in advance in the on-line mode. The stimuli may include, e.g. sounds, flashing/blinking images (pictures), etc. For instance, EEG data analysis may include methods of machine learning and mathematical statistics in order to detect user's brain response to the given stimuli in the EEG data. Non-invasive BCIs do not require connecting any registering devices, particularly, sensors, directly to the user's brain. Specifically, EEG data analysis allows to determine at least an EEG data segment and the moment in (or a period of) time, when the user sees the stimulus and responds to it. In an exemplary case, the stimulus is shown to the user on the computing device display. In an exemplary case, this stimulus may be a flashing/blinking image, e.g. a square, a rectangle, a circle, etc.

There are conventional systems and methods for user interactions with various devices. Such systems allow people with disabilities to interact with the world around them, particularly, drive wheelchairs or type texts on computing devices. Please note that the locked-in syndrome is also considered a disability. Other kinds of disabilities may be caused by severe spinal injuries, strokes, etc. The drawbacks of conventional methods and systems include extremely low speed and performance, as well as limited use.

Other conventional methods and systems are used for controlling GUIs via a BCI, wherein the commands are sent to the mouse controller step by step to move the cursor in one of the four directions, and wherein commands are generated when the user focuses on corresponding stimuli. One of the drawbacks of such methods is low speed, as they require multiple instances of the command being input in a sequence by the user so that the mouse cursor can reach the desired area for interaction with the interface. In an exemplary case, user interaction with the interface consists of pressing/clicking a mouse button, particularly, imitating such pressing/clicking.

There are also conventional methods and systems for brain-computer interfaces designed for 2D cursor control. Such systems describe control over the mouse cursor via BCIs based on evoked potential/evoked P300 (P3) wave and ERD/ERS technologies. One of the drawbacks of such methods is low speed and accuracy of user-GUI interactions.

Therefore, there is a need for a method and system that would overcome the cited drawbacks, or at least some of them.

### SUMMARY

The objective of the present technology is to provide a quick and precise (reliable) way to control any GUI (Graphic User Interface) contactlessly.

An exemplary embodiment of the method for contactless user interface, the method executable by a computer, the method comprising:

a) receiving at least one command the user intends to execute; b)setting the visible GUI as the currently active area; c) displaying said currently active area; d) dividing said currently active area into a number of rectangular sub-areas equal to the number of available stimuli provided by the BCI; e) displaying unique visual stimuli for each sub-area by means of the BCI; f) identifying, by means of the BCI, the target stimulus corresponding to the sub-area, in which the user command is intended to be executed; g) obtaining the sub-area corresponding to the target stimulus identified; h) in response to the obtained sub-area being enough to determine the user's intention, wherein the conditions for specifying that the sub-area is enough to determine the user's intention include at least one of: the command, when executed in any point of the given sub-area, returns the same results; or the current size of the given sub-area corresponds to the minimum allowable size; or the current size of the given sub-area is 1 pixel:
executing the command in the obtained sub-area; i) in response to the obtained sub-area being not enough to determine the user's intention: increasing the scale and setting the obtained sub-area as the currently active area, then repeating the steps c-i.

An exemplary embodiment of the present method for contactless user interface comprises the following steps: a) obtaining at least one user command and a GUI area, where the user wants to perform said command; b) setting said GUI area as the currently active area; c) obtaining at least two sub-areas of arbitrary shape and size covering the area that is potentially available for performing said command by dividing the currently active GUI area; d) displaying at least one visual stimulus corresponding to at least one sub-area mentioned above to the user; e) identifying at least one target stimulus corresponding to the sub-area, with which the user wants to interact; f) obtaining a sub-area corresponding to the target stimulus; g) determining whether the sub-area obtained in the previous step is enough to specify the user's intention exactly, wherein in case the sub-area obtained is enough for said purpose, then the at least one user command obtained in step a) is performed in the given sub-area; otherwise, this sub-area is set as the currently active area, and steps c)-g) are performed again.

Another exemplary embodiment of the present method for contactless user interface comprises the following steps: a) obtaining at least two GUI sub-areas of arbitrary shape and size from a third-party application; b) displaying at least one visual stimulus corresponding to at least one sub-area mentioned above to the user; c) identifying at least one target stimulus corresponding to the sub-area, with which the user wants to interact; d) obtaining a sub-area corresponding to the target stimulus; e) notifying the third-party application that said sub-area has been identified.

In an exemplary embodiment, the area that is set as the currently active area is scaled.

In an exemplary embodiment, the target stimulus is identified by means of a BCI.

In an exemplary embodiment, BCIs based on CVEP, SSVEP or P300 are used.

An exemplary embodiment further comprises voice commands registered by a microphone, and/or an eye movement tracking system, and/or a mouse, and/or a keyboard that are used to identify the target stimulus.

In an exemplary embodiment, each stimulus is routinely checked to measure the probability of it being the target stimulus.

In an exemplary embodiment, after the currently active area has been obtained, its sub-area borders are displayed.

In an exemplary embodiment, the sub-area borders are displayed on a separate GUI layer.

In an exemplary embodiment, displayed stimuli are partially transparent.

An exemplary embodiment further comprises giving sound and/or tactile stimuli to the user.

In an exemplary embodiment, mental commands, as well as emotional, psychological and physical states of the user a registered and considered when identifying the target stimulus.

In an exemplary embodiment, the currently active are is scaled either gradually or instantly.

In an exemplary embodiment, a command is a set of instructions for an operating system, a GUI, some application or a device, including a virtual one.

In an exemplary embodiment, a command is point-based, coordinate-dependent way of interacting with a GUI.

In an exemplary embodiment, a command is pressing of a mouse button, a double click on a mouse button, or a finger touch.

In an exemplary embodiment, a command is an imitation of pressing a key on a keyboard, or a combination of keys.

In an exemplary embodiment, a command is a combination of two or more commands

In an exemplary embodiment, the area that is potentially available for performing a command is a part of the user interface, where the performing of a command yields some result.

In an exemplary embodiment, the sub-area is considered to be enough for performing a command if one of the following conditions has been met: the sub-area size is equal to a pre-set minimum size; the command yields the same result, when performed in any point of the sub-area; the sub-area size is equal to one pixel.

In an exemplary embodiment, the sub-area borders are displayed on a separate GUI layer.

In an exemplary embodiment, after the target stimulus has been identified, all stimuli are switched off.

In an exemplary embodiment, there may be pauses between the steps described in claim 1 of the present method.

In an exemplary embodiment, the scaled area will cover some GUI elements that were previously displayed to the user.

In an exemplary embodiment, at least one GUI element is not scaled along with the currently active area.

In an exemplary embodiment, along with a sub-area being scaled, at least one part of at least one other sub-area is also being scaled.

In an exemplary embodiment, several sub-areas or parts thereof may be scaled by scaling some GUI area that contains these sub-areas or parts thereof.

In an exemplary embodiment, the currently active area is divided into sub-areas following the lines of a rectangular or a curvilinear, or any other type of 2D grid.

In an exemplary embodiment, the area is divided based on the following parameters: number of sub-areas, their sizes, areas, division grid step, division line shapes.

In an exemplary embodiment, the currently active area is divided with respect to GUI elements located there, with which the user can interact.

In an exemplary embodiment, a menu is displayed to the user for obtaining and/or performing a command and/or confirming that the sub-area is enough and/or interacting with third-party applications.

In an exemplary embodiment, the menu is displayed separately from the GUI, it is not scaled and is always visible to the user.

In an exemplary embodiment, sub-areas corresponding to menu items are added to the sub-area obtained by dividing the currently active area or from a third-party application.

In an exemplary embodiment, the menu permits third-party applications to register their own elements and commands

In an exemplary embodiment, the menu notifies the third-party application in case a menu sub-area that corresponds to an element or a command registered by the application has been identified.

In an exemplary embodiment, the user is permitted to create their own commands

In an exemplary embodiment, the menu is displayed after the sub-area corresponding to the target stimulus has been identified.

In an exemplary embodiment, the area and/or its sub-areas described above are defined with global screen coordinates, on a screen that display the GUI.

In an exemplary embodiment of the present technology, third-party applications are provided an API to control operation of the system.

In an exemplary embodiment, a third-party application may use API to find out the system's degree of certainty that the user wants to interact with at least one particular sub-area.

In an exemplary embodiment, a third-party application may use API to perform a command based on the sub-area that has been identified.

In an exemplary embodiment, the system may process sub-areas defined by applications or the menu, other than those defined by a third-party application.

In an exemplary embodiment, when a third-party application defines any sub-areas, those already defined are no longer processed or recognized.

In an exemplary embodiment, the sub-area identification notification is sent only to the application and/or menu that has defined said sub-area.

An exemplary embodiment further comprises displaying a virtual keyboard, wherein the set of keys is the area available for performing commands, and the keys themselves are sub-areas that the keyboard is divided into, which are all enough for performing commands

An exemplary embodiment further comprises imitating pressing of a key that corresponds to the sub-area that has been identified.

In an exemplary embodiment, the virtual keyboard operates according to the described API.

An exemplary embodiment further comprises imitating a mouse controller in the following way: setting the entire GUI as the initial currently active area; dividing this area along the regular rectangular grid of a fixed size; after a sub-area has been set as the currently active area, scaling this sub-area until its size equals that of the GUI.

In an exemplary embodiment, a mouse controller is imitated by a separate application and operates according to the described API.

In an exemplary embodiment of the present technology, the stimuli that are presented may be of various sizes and shapes, they may have various transparency, blinking algorithms and rates, brightness, angular diameters, volumes, areas, rotation angles, and they also may be located in various parts of associated sub-areas and/or GUI parts.

### BRIEF DESCRIPTION OF THE ATTACHED FIGURES

The objects, features and advantages of the technology will be further pointed out in the detailed description as well as the appended drawings. In the drawings:

FIG. 1A shows an exemplary embodiment of the system to carry out the method of the present invention.

FIG. 1B shows an exemplary embodiment of the system to carry out the method of the present invention.

FIG. 1C shows an exemplary embodiment of the system to carry out the method of the present invention.

FIG. 2 shows an exemplary GUI, in this case, a desktop environment in an exemplary embodiment of the present invention.

FIG. 3 shows an exemplary GUI with the target stimulus that has been identified for a corresponding sub-area in an exemplary embodiment of the present invention.

FIG. 4 shows an example of scaling of a sub-area and its further display in an exemplary embodiment of the present invention.

FIG. 5 shows an example of further scaling of the sub-area 446 in an exemplary embodiment of the present invention.

FIG. 6 shows an exemplary GUI with division and a side-panel menu, also divided, in an exemplary embodiment of the present invention.

FIG. 7 shows an example of non-rectangular division in an exemplary embodiment of the present invention.

FIG. 8 shows an example of non-rectangular division with sub-area borders that will be displayed after scaling in an exemplary embodiment of the present invention.

FIG. 9 shows an example of display of a scaled sub-area and adjacent sub-areas in an exemplary embodiment of the present invention.

FIG. 10 shows another exemplary GUI with division and a side-panel menu, also divided, in an exemplary embodiment of the present invention.

FIG. 11 shows the flowchart of an exemplary algorithm for the present method according to an exemplary embodiment of the present invention.

FIG. 12A shows an exemplary embodiment of the system to carry out the method of the present invention.

FIG. 12B shows an exemplary embodiment of the system to carry out the method of the present invention.

FIG. 12C shows an exemplary embodiment of the system to carry out the method of the present invention.

FIG. 13 shows an example of giving stimuli according to an exemplary embodiment of the present invention.

FIG. 14 shows exemplary stimuli in static and/or flashing, and/or changing shape and/or movement according to an exemplary embodiment of the present invention.

FIG. 15 shows another example of division and giving stimuli according to an exemplary embodiment of the present invention.

FIG. 16 shows an exemplary general-purpose computer system.

### DETAILED DESCRIPTION

Objects and features of the present invention, methods for achieving these objects and features will become apparent by reference to the exemplary embodiments. However, the present invention is not limited to the exemplary embodiments disclosed below, it may be embodied in various forms. Summary contained in the description, is nothing but specific details secured to aid those skilled in the art in a comprehensive understanding of the invention, and the present invention is only defined within the scope of the appended claims.

The terms “module”, “component”, “element”, etc. mentioned in the present disclosure are used to denote computer-related entities, such as hardware (e.g. a device, an instrument, an apparatus, a piece of equipment, a constituent part of a device, e.g. a processor, a microprocessor, an integrated circuit, a printed circuit board (PCB), including printed wiring boards, a breadboard, a motherboard, etc., a microcomputer, etc.), software (e.g. executable programming code, a compiled application, a program module, a part of software or programming code, etc.), and/or firmware. For instance, a component may be a processor-executed process, an object, executable code, programming code, a file, a program/an application, a function, a method, a (program) library, a sub-program, a co-program, and/or a computing device (e.g. a microcomputer or a computer), or a combination of software or hardware components. Thus, an application run on a server, in an exemplary case, may be a component/module, while the server may be a component/module, too. Please note that at least one component/module may be a part of a process. Components/modules may be located in a single computing device (e.g. a microcomputer, a microprocessor, a PCB, etc.) and/or distributed/divided among several computing devices.

A brain-computer interface, or BCI, is a system for exchanging information between a human/user's brain and an electronic device, particularly, a computing device. BCIs allow to receive and/or recognize, and/or process brain signals, which, in turn, may be used to control a computing device. BCIs also allow to recognize the user's intention to input at least one of the possible commands (e.g. those available to select from), e.g. based on user's biological data.

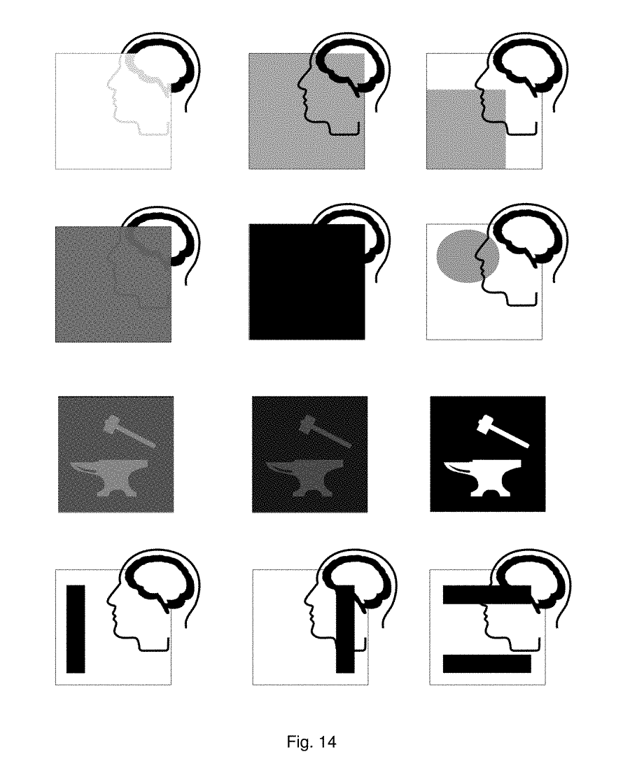

In the present disclosure, a stimulus is (any) influence (impact) on the user. Please note that, in an exemplary case, a biological brain signal for a deliberate or non-deliberate user response to a stimulus is being recognized. The signals may be recognized by means of a BCI or some other system. A stimulus may be a flashing square or any other geometric shape, or an image that is changing its size, transparency, rotation angle, position on the screen of a computing device, etc. (Exemplary stimuli are shown in FIG. 14.) Stimuli may also include other images on the screen, wherein it is possible to recognize that the user is focusing and/or looking at one of those images. Also, along with visual stimuli, the user may be given audible stimuli, such as an audio recording or any other sound signal, or tactile stimuli. Other stimuli may include all sorts of appeals to the user, particularly, those urging them to perform a mental command Please note that such appeal may be displayed on the screen. Also, such appeal may be produced by speakers, voice, or may be given to the user in any other known way. For instance, an appeal may look like “Imagine closing your right hand” or “Close your eyes, please”, or sound like “Relax”, etc. In this case, if the user responds to the “Close your eyes, please” appeal by closing their eyes, this physical action can be recognized by at least one of the modules of the present system. Also note that the user's response is recognized by the means of the present system (e.g. its module), particularly, a BCI. Said means, i.e. modules or their parts, are capable of sending commands to the (electronic) computing device. In this preferred embodiment of the present invention, an exemplary stimulus is a rectangular area on the screen of a computing device, and displaying parameters of this area are changed according to a pre-set algorithm (law, condition, etc.). For instance, such algorithm may include a display rule described by a function depending on the current time and determining color, transparency, size, position, etc. in each moment in time. In the exemplary case, the stimulus changes its color from black to white and back with the passage of time, which equals to blinking in the corresponding part of the screen. Please note that the screen may hold several stimuli at the same time, wherein each stimulus has its own law/algorithm for changes, and, respectively, its own user's brain signal, when the user focuses their gaze at one of those stimuli.

The target stimulus is the stimulus, on which the user is deliberately focusing, and/or the stimulus, with which the user wants to interact.

Target stimulus identification comprises a sequence of events, within which the user has an opportunity to respond to any stimulus that is given to them. In an exemplary embodiment of the present invention, target stimuli are recognized by means of a BCI or an other system. For instance, to identify the target stimulus is to determine the stimulus, with which the user is interacting (particularly, that, on which the user is focusing) by recognizing the signal, e.g. the user's brain signal by means of a BCI. For instance, when focusing on the target stimulus, the user's brain generates a signal that may be compared to signals stored in the database (data storage). Please note that signals may correspond to specific target stimuli. Also note that signals may be compared by means of at least one module of the present system.

In this exemplary case, a Graphic User Interface (GUI) is a variety of a user interface. In a GUI, interface elements, such as menus, buttons, icons, etc., that are displayed to the user, are graphic images. Please note that a GUI may have the following property: it can be navigated by sending commands to interface elements. Exemplary GUIs include an operating system GUI, an application GUI, particularly, a browser GUI, a mobile app GUI, etc.

A command is a set of instructions for an operating system, a GUI, some application or a device, including a virtual one. In this exemplary case, a command is one of point-based, coordinate-dependent ways (methods, mechanics, etc.) of interacting with a GUI, that are provided by this GUI. Such commands include, e.g. right mouse click, left mouse click, finger tap, etc.

An area is a part of the GUI. In an exemplary case, when an area is being displayed to the user, it is its state in the current or some fixed moment in time that is being displayed. The area may be modified when being displayed. For instance, its scale may be changed. In an exemplary case, the area image may occupy the whole screen. Besides, e.g. over or near the area, additional elements may be displayed (see below). In an exemplary case, these additional elements may be shown on a separate GUI layer. Also, in an exemplary case, one, two or more areas may be displayed at the same time. If one area is a part of another area (after its division), then it can be labeled as a sub-area of that area. In an exemplary case, an area may be a rectangular part of the GUI.

In some GUIs, particularly, window-based ones, interface elements may be shown simultaneously, covering each other, wherein some elements may be considered to be virtually “above” or “below” other elements. In an exemplary case, GUI elements may be virtually situated on different layers, wherein the positions of those layers relative to each other have been specified. Thus, all elements situated on a given layer are collectively “above” or “below” all elements situated on a different layer, according to the relative positions of those layers.

The intended area is a part of the GUI, where the user intends to perform a command

Scaling means gradual or instant change in size of a displayed area.

Division means division of a GUI area into smaller areas (sub-areas). The larger area is also visually divided, e.g. through rendering of outlines/borders of said sub-areas.

An area that is potentially available for performing a command is a part of the user interface, where the performing of a command yields some result. For instance, an icon on the desktop of an operating system is such potentially available area for the “left mouse click” command At the same time, an empty area on the desktop of an operating system, in an exemplary case, is not such area for the “left mouse click” command, since performing this command there will not yield any result or any consequences/response.

In an exemplary case, the application that carries out the present method is an algorithm or a computer program, which uses the method of the present invention to enable interaction with a certain GUI.

In the present disclosure, CVEP (Code Modulated Visual Evoked Potentials) means the method described in the article titled “A high-speed BCI based on code modulation VEP” (doi: 10.1088/1741-2560/8/2/025015).

In the present disclosure, SSVEP means the method described in the article titled “High-speed spelling with a noninvasive brain-computer interface” (DOI: 10.1073/pnas.1508080112).

P300 is a component of the wave of a brain response to a stimulus, being a positive voltage shift in the electroencephalogram 250-500 msec after the stimulus has been given. Several BCIs have been designed based on the analysis of this component.

ERD/ERS (event-related desynchronization/event-related synchronization) relates to mental representation of certain actions, which cause increase in certain frequencies in the EEG. This principle may be used as a basis for designing BCIs.

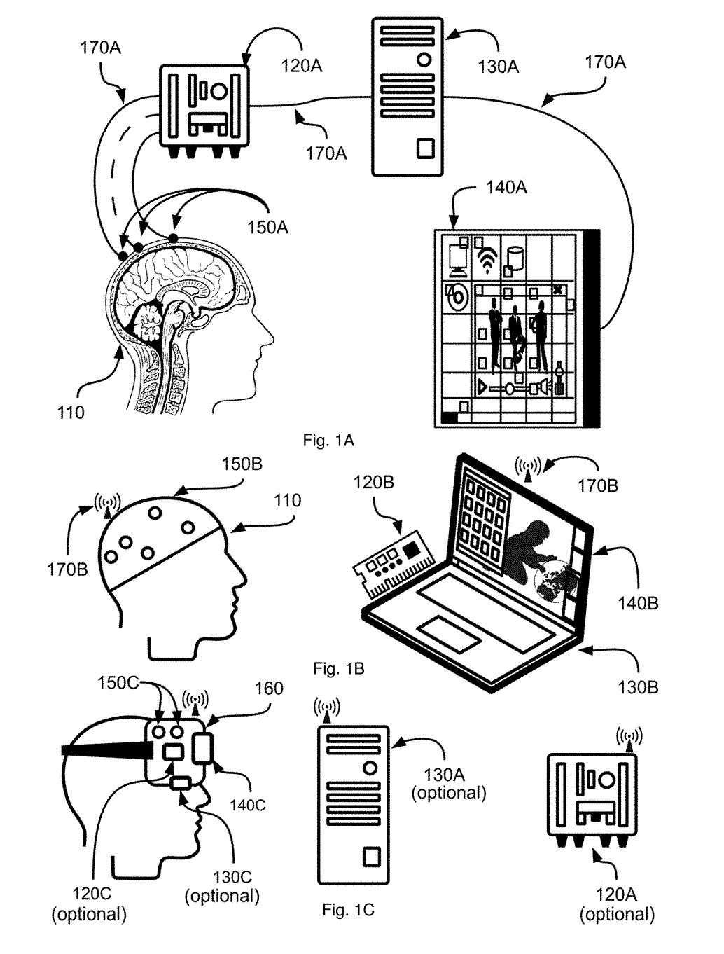

FIG. 1 shows various exemplary embodiments of the system to carry out the present method. In an exemplary case, the system of the present invention comprises some means (in an exemplary case, a system, a device, a module, etc.) for video signal playback and visual information display 140A, 140B, 140C. The displaying means 140 (140A, 140B, 140C) may be connected to the computing device (130A, 130B) or may be a part of it. This connection between the means 140 and device (130A, 130B) may be made, e.g. via a wired and/or wireless communication means (module). Please note that the communication means (module) may be implemented as a communication device. The means 140 may be represented by a monitor, a display (e.g. of a computing device), a screen (e.g. of a TV set or a VR goggles/headset), an indicator, etc. The displaying means 140 may also be represented by registering playback means or graphic display means. Please note that registering playback means include both mechanical and non-mechanical devices. Graphic display means mentioned above include direct display means and image projecting means. The means 140 may include devices, where informative prints are produced by putting coloring agent onto a carrier by a field. In other devices, informative prints may be produced by changes in the carrier substance composition. The means 140 may include devices, where informative prints are produced by putting coloring agent onto a carrier, particularly, through attraction of elementary particles of said coloring agent by electric and/or magnetic fields. The means 140 may also include electrophotographic, electrostatic, ferrographic, thermographic, photographic, diasographic, electrochemical, electric-spark, or thermoplastic devices, as well as direct display or image projecting means, specifically with CRTs (both conventional and Charactrons) or with matrix-based character indicators, Charactrons, or CRTs. The means 140 may also include devices that use ready-made sets of characters: Nixie tubes (cold cathode displays), light grates, fiber-optic indicators, character drums, streamers, incandescent tubes, electroluminescent indicators/displays or liquid crystal-based indicators/displays, as well as electronic-optical, electromechanical or laser systems, direct vision systems, film projectors, stylographic, holographic or laser systems, or systems with passive and active screens. Hereinafter, these video signal playback and information display means 140 (specifically, modules, devices, etc.) will be discussed through the example of a PC/laptop display, which in turn are exemplary computing devices. Please note that the present invention is not limited in the way that it is usable with a display only.

Please note that at least two of the described modules (specifically, means, devices, etc.) of the present system may be combined into a single module. For instance, the displaying means 140A/140B/140C and/or registration module/sensor(s) 150A/150B/150C, and/or data processing module 120A/120B/120C, and/or computing module 130A/130B/130C, etc. may be combined into a single module 160. In an exemplary embodiment, the module 160 may be represented as a BCI module, and/or a VR headset, etc.

Computing devices (130A, 130B) mentioned above may include a mobile device, such as a tablet, a smartphone, a phone, etc., or a stationary device, such as a workstation, a server, a desktop computer, a monoblock, etc.

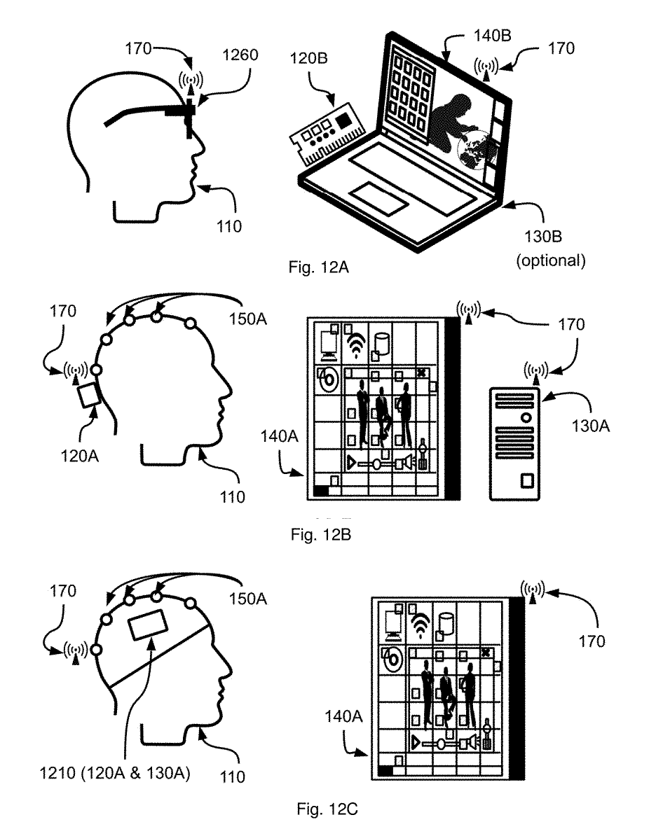

The present system may comprise at least one data processing module 120. In some embodiments, the module 120 may be represented as an individual module (specifically, a device) 120A or may be a part/an element of at least one of the modules of the present system, e.g. a computer board/module 120B. The board 120B may be mounted or integrated into the computing device (e.g. 130B), or may be connected to it via a wired and/or wireless connection, communication, junction, mounting, etc. The data processing module 120 may receive data/information from registering modules 150 (150A, 150B), which, in an exemplary case, are sensors and/or devices, particularly, modules. For instance, registering modules are capable of registering and/or monitoring actions, activity, etc. (see a detailed description below) of the user, and/or at least one body part of the user, e.g. activity (including movement) of the eyes, brain, etc. For instance, such sensors and/or devices 150A, 150B (which also may comprise at least one sensor mentioned herein) are capable of registering, transmitting and/or storing signals received from the user, wherein such registering modules 150 may comprise data processing modules 120. Registering modules may include devices that read user's biological data, such as: electroencephalographs, MRI scanners, electrocardiographs, etc. Registering modules may also include input devices, e.g. mouse manipulators, keyboards, joysticks, video cameras (including web-cameras), cameras, frame grabbers, microphones, trackballs, touchpads, tablets (including graphic tablets), sensor screens, computer vision devices, e.g. Kinect, (computer) steering wheels, dance pads, pedals, IR guns, various manipulators, eye movement trackers, movement sensors, accelerometers, GPS modules/sensors, volume sensors, IR sensors, means for registering and recognition of movements of the user (or their body parts), VR headsets, AR/VR goggles, Microsoft Hololens, kinaesthetic detectors, wearable sensors (e.g. special gloves), eye movement detectors 1260 (see FIG. 12), such as Google Glass or special cameras, IR cameras, Siri or similar models/systems (particularly, sensors with background speech recognition modules, either integrated, external or server-based), etc.

In an exemplary embodiment of the present invention, registering modules (150A, 150B) may be connected to at least one data processing module 120. Please note that the data processing module 120 may be connected to at least one computing device (module) 130, which in turn may be connected to at least one displaying means 140. Also note that the data processing module 120 and/or registering module 150 may comprise a communication module (particularly, a module for receiving and/or transmitting data), as well as a data storage module.

At least one module of the present invention (e.g. modules and/or means 120, 130, 140, 150, 170 etc.) may be represented by at least one computing device, such as a microcomputer (e.g. Arduino, Raspberry PI(3), Intel Joule, LattePanda, MK802, CuBox, Orange Pi PC, etc.), a microcontroller/minicontroller, an electronic board, etc., or at least one part thereof that is enough to perform at least one function (functional capability) of the module/device/system/sub-system. Please note that other functions of the described module may be performed by at least one other system module. In an exemplary embodiment of the present invention, at least one module of the present system may comprise a microcomputer (which, in turn, may comprise a processor or a microprocessor) with an operating system (e.g. Windows, Linux, etc.) installed thereon. Please note that modules described herein, particularly modules of a microcomputer, a computing device, a display, etc., may also be either constituent parts of a microcomputer/microcomputers, or separate modules represented by at least one computing device, programming component (e.g. a virtual or program-emulated physical device), processor, microprocessor, electronic circuit, device, etc. These modules may be connected to each other by at least one connection type (either wired or wireless), including various bus structures (e.g. system bus, periphery bus, local bus, memory bus, etc.), various interfaces (serial port, parallel port, game port, USB (universal serial bus), network interface, etc.), adapters (e.g. display adapter/video adapter, network adapter, controlled adapter, USB adapter, etc.), and so on. For instance, in an exemplary case, one system module or at least one set of modules, comprising any number of system modules of any type, may be at least one microcomputer and/or may be connected to at least one microcomputer.

At least one of the modules described herein may be connected to at least one of other system modules or to external modules via at least one communication module (means) 170. In some embodiments, the communication module (means) 170 may be either wired (170A) or wireless (170B).

The modules described herein, such as 120, 130, 140, 150, etc., and/or their constituent parts may be connected to each other via wired and/or wireless communication means (methods), and also via various types of connections, including detachable or non-detachable (e.g. through terminals, contacts, adapters, soldering, mechanical connectors, threading, etc.) wires, etc. For instance, such communication means may be represented by local area networks (LAN), USB interface, RS-232 standard interface, Bluetooth or Wi-Fi interface, Internet, mobile cellular communications (GSM), particularly, in the 850-1900 MHz band, satellite communications, trunked communications and data transfer channels with ultra-low power consumption that generate complex wireless networks with cellular topology (ZigBee), and other types of communications/connections. In an exemplary embodiment of the present invention, data may be transferred between modules/devices/systems of the present invention via various protocols, such as HTTP (HyperText Transfer Protocol), HTTPS (HyperText Transfer Protocol Secure), FTP (File Transfer Protocol), TCP/IP, POPS (Post Office Protocol), SMTP (Simple Mail Transfer Protocol), TELNET, DTN, etc., including protocols of IEEE 802.15.4 and ZigBee standards, including APS (application support sublayer) and NWK using bottom-level services, such as MAC environment access control level and PHY physical level, etc.

The method and system of the present invention allow at least one user to interact with an interface (particularly, a GUI), specifically, via a brain-computer interface or any other interface type, including a human-machine interface, a hardware interface, an input or output interface, and/or an input/output interface.

In an exemplary embodiment of the present invention, the method and system allow the user (specifically, by means of a BCI) to perform a specific command, including a pre-determined one, in an intended area of the (graphic/visual) interface. For instance, applying of a “mouse click” (or finger tap, or any other way of interacting with interface (graphic) elements) command to a PC (computing device) desktop icon is an exemplary implementation of the functionality of the present method and system. In this case, the desktop is the GUI; the icon is the intended area; and the mouse click is the command In some embodiments, commands may be programmed in at least one module of the present system, particularly, in the computing device, data processing module and/or registering module, etc. mentioned above.

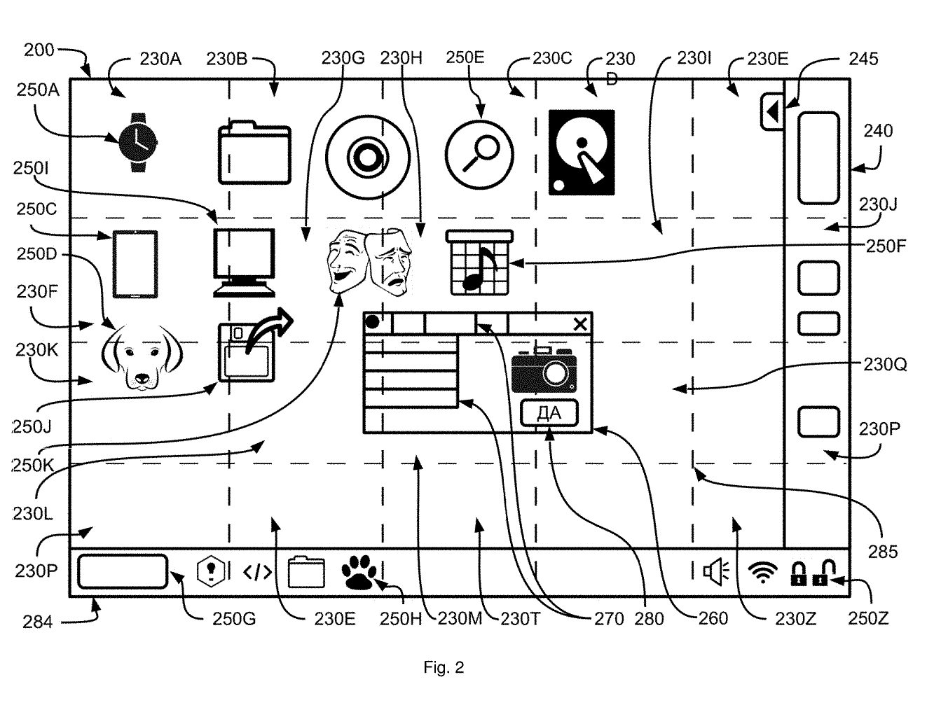

The display module 140 screen may display various graphic elements (areas) of the GUI 200 (see FIG. 2), such as icons/shortcuts, buttons (250G), applications, parts/elements of applications, operating system, OS windows, application windows 260, etc., with which the user may interact this way or another, e.g. by means of (data) input devices, registering modules 150, etc.

FIG. 2 shows an exemplary GUI, in this case, a desktop environment (desktop being an exemplary graphic shell) in an exemplary embodiment of the present invention. As described above, the GUI may include various graphic elements (250A . . . 250Z), including shortcuts (icons), buttons, e.g. graphic buttons, tabs, menu items 270, application buttons 280, images, etc., which can be (potentially) interacted with by the user.

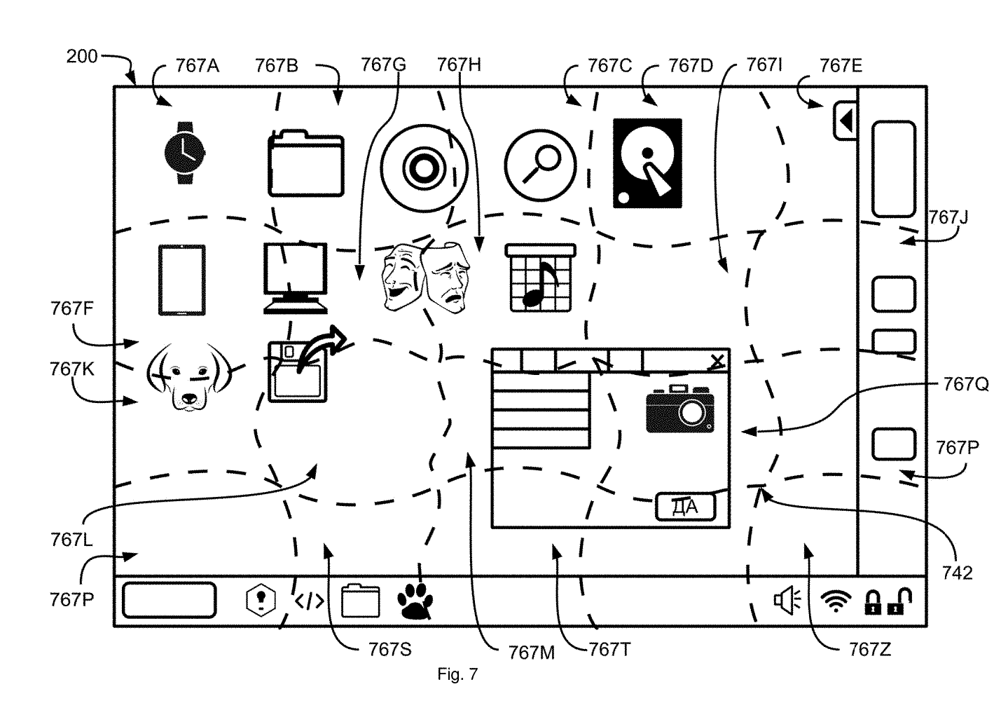

In an exemplary embodiment of the present invention, the entire area of the GUI 200 (and/or at least one part thereof) may be subdivided into any number of sub-areas. The GUI 200 area may be subdivided virtually and/or visually by means of at least one of the modules of the present system. For instance, the GUI area may be subdivided by means of the division algorithm executed by the software installed on the computing device 130 (and/or on the data processing module 120, and/or on the registering module 150). The GUI division algorithm may subdivide the given GUI area into sub-areas of various shapes and sizes (230A . . . 230Z in FIG. 2, 767A . . . 767Z in FIG. 7). Said sub-areas may be of square and/or rectangular shapes, of arbitrary shapes, etc. The results of division may be stored, e.g. in RAM, application, database, data storage, such as hard disk drive, network-based or cloud storage, etc. For instance, coordinates of division line intersections, line shapes, division and line construction formulas, etc. may be stored in such way. Also, over at least one sub-area resulting from the division, at least one stimulus may be displayed, which will be described below in more details. In an exemplary case, dashed lines 285 shown in FIG. 2 may be used as visual representation of the implementation of the algorithm for dividing area(s) of visualized data (particularly, the GUI), specifically, into rectangular sub-areas 230A . . . 230Z. The area may also be divided with a 2D division grid. In an exemplary case, the division grid is displayed in dashed lines 285 (see FIG. 2), 742 (see FIG. 7). Please note that such division may be not rendered, i.e. not displayed, to the user. Also, FIG. 7 shows an example of the GUI area 200 being divided into arbitrary sub-areas 767A . . . 767Z.

Please note that the subdivision described above may be implemented using the facilities of the operating system or at least one application, including those implementing at least one part of the method and system disclosed herein. In an exemplary embodiment, this application renders/displays stimuli and subdivision described above.

Within the present invention, the user may be shown a menu 240, that may also contain stimuli, graphic (rendered, displayed) elements (such as buttons, icons, text, etc.) and other things. Please note that the menu may be a part of an application, or of a GUI, or of an operating system, etc. Please note that the menu 240 for user interaction with the described areas and/or GUI and its parts (including GUI elements) may be implemented by at least one of the modules of the present system. Also, the menu 240 may be implemented through program means of such modules, including computing device 130 means.

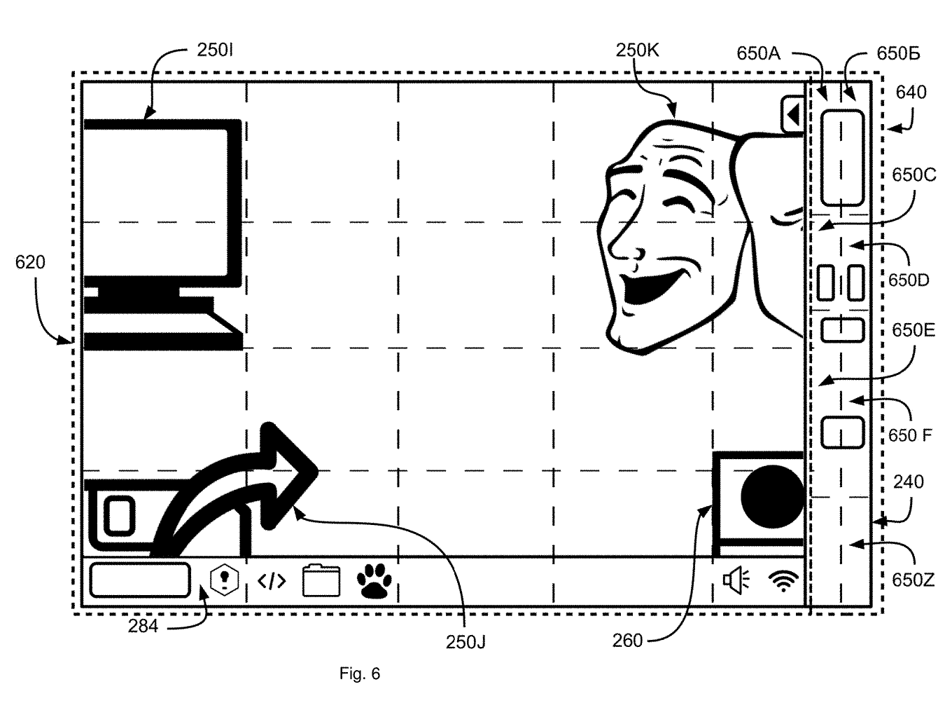

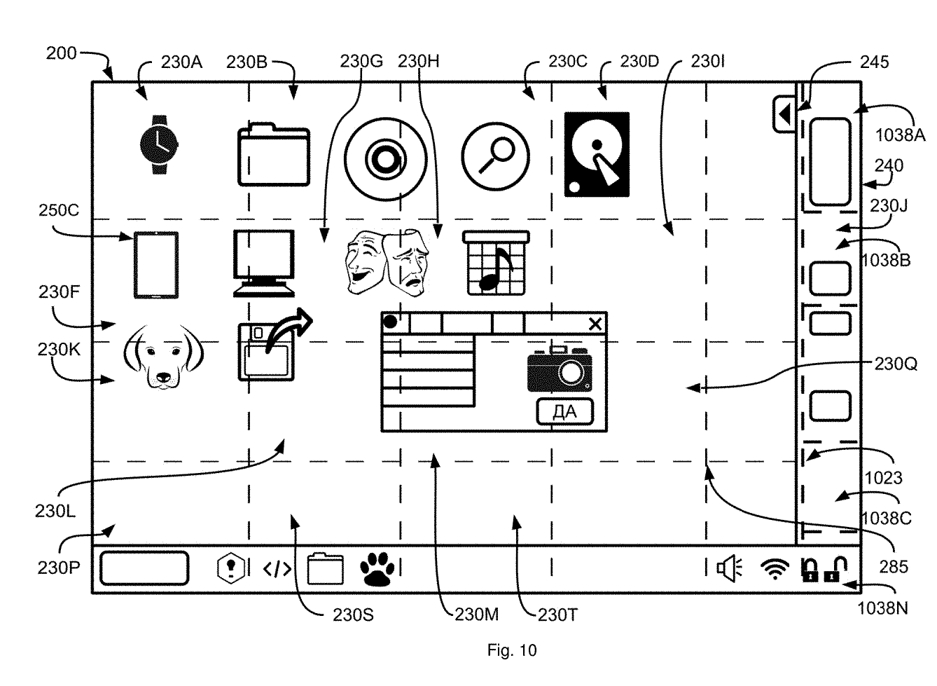

Please note that the menu may be displayed both over the GUI and separately. In this case, in order to fit the GUI and/or its parts into the screen, they may be scaled down (squeezed). The menu may be further (sub)divided (by means of at least one module of the present system) into sub-areas, e.g. 1038A . . . 1038N, as shown in FIG. 10, using one of the methods of the present invention. For instance, the division into sub-areas may be done through a division algorithm, wherein at least one of said sub-areas may contain at least one stimulus. Please note that the described division of area(s), particularly, of the GUI, including division of menu, may be done simultaneously. Also note that the described division may (further) comprise the division of the entire GUI 200 area, including the menu 240 or an area thereof 1023. Also, in an exemplary embodiment of the present invention, the areas may be divided individually, e.g. the GUI area (or a part thereof), such as 620 in FIG. 6, and the (additional) menu area, such as 640 in FIG. 6, particularly, containing other stimuli than those contained in the area 620.

In an exemplary case, the menu may be made as a side panel. FIG. 10 shows an exemplary GUI with division and a side-panel menu, also divided, in an exemplary embodiment of the present invention.

Also, various applications of at least one interface (particularly, such as described above), e.g. those which are active at a given moment, may be allowed by at least one module of the present system to put their commands into such panel (menu). E.g. an opened video player (audio and/or video playback software) or any other application, such as a 3D software, graphic editor, video editor, etc., may put its command, e.g. “start playback”/“stop” (or any other command), which will return the process into said application and perform an associated action, whenever a corresponding target stimulus is recognized.

Please note that said menu may be shown permanently to the user, or it may be displayed (opened) via a graphic element, menu item, etc., e.g. via the element 245 in FIG. 2, which may also have a corresponding stimulus. Also, the menu may be displayed to the user after at least one stimulus has been identified, particularly, a target stimulus (for more details, see below). This may be done, e.g. in order to re-specify a command that must be performed after the area corresponding to a target stimulus has been identified. Please note that said menu may also be divided (partitioned) into areas, each of which may be assigned with at least one stimulus. In a particular case, each menu item may be located in its individual sub-area, when the menu is being partitioned.

As mentioned above, said division/partition of the information displayed to the user may be performed through at least one algorithm for division/partition of areas into sub-areas. In some exemplary embodiments, the information displayed to the user is the GUI of a computing/electronic device. Such software and/or hardware algorithm may employ mathematical formulas, algorithms, functions, methods, techniques, etc. (including conventional algorithms for partition of sets into sub-sets (see e.g. https://en.wikipedia.org/wiki/Partition_of_a_set), or of images into parts (https://en.wikipedia.org/wild/Image_segmentation), or of areas into constituent parts, etc.), including the process of generating of such sub-areas to be divided as described.

Also, the division algorithm may use characteristics/parameters of the modules of the present system, such as the computing device 130 (e.g. its computing power), display module 140 (e.g. its screen resolution, size, etc.), registration module 150 (e.g. its number of sensors, data registration speed, etc.), data processing module 120 (e.g. its data processing speed), communications module 170 (e.g. its data transmission speed), and/or user's physiological parameters and features 110 (e.g. their age, reaction speed, brain activity level, diseases, abnormalities, etc.) and others. The division algorithm may also employ environment parameters, such as light level, distance between the user and the screen, etc.

For instance, the algorithm may receive the parameters of the image on the computing device screen 130 and/or the display module 140 screen resolution, e.g. in dots per unit area/length, from the computing module 130 and/or display module 140, e.g. by means of software, drivers, operating system, etc., including queries and feedback from said modules and components. Then, the division algorithm may use the obtained values, e.g. the number of dots in the display module 140 both horizontally and vertically, to determine the number of sub-areas, into which the area (particularly, the GUI area or a part of it) may be divided. The number of sub-areas, into which the area of the GUI/menu/etc. will be divided, may be calculated using variables or constant values, particularly those that are determined/set by at least one module of the present system and/or the user, e.g. through inputting data by means of an interface, including a GUI, particularly, a menu, a command line, etc. Specifically, the user may be a patient, an operator, a specialist, a doctor, a researcher, etc. For instance, height and width of at least one sub-area that may result from division may be determined. Also, the number of sub-areas, into which the GUI area may (or will) be divided, may be determined.

Please note that the division may be displayed/rendered, e.g. as a grid, lines, cells, zones, etc. by means and tools of the display module 140 and/or computing device 130, etc., wherein such means may include module software and/or hardware, such as applications, drivers, instructions for graphic cards, operating systems, processors, microprocessors, controllers, etc.

Also note that at least one division parameter may be set by the user, e.g. through an interface, particularly, of an application that is capable of implementing the method of the present invention.

Therefore, the information displayed on screen, particularly, the area (O) may be divided into smaller areas (also known as sub-areas) O1 . . . ON that cover the area that is potentially available for performing the command. Particularly, sub-areas O1 . . . ON may cover the entire area O or only some parts thereof, in case the command can only be performed in those parts. The number N of sub-areas may be limited by the chosen BCI, e.g. by the maximum number of target stimuli that can be recognized simultaneously. In an exemplary case, the described division of GUI areas into sub-areas may be used to explain to the user, with which sub-area exactly they will continue to interact after the target stimulus is identified. Please note that a stimulus may be identified by various methods, means, mechanisms, modules, systems, etc., wherein actual identification methods may differ depending on the BCI in use. For instance, in CVEP, a stimulus may be identified by means of comparing a registered signal with the signals stored in the database. Please note that those signals may include signals that have been recorded before, particularly, for the same user, or for a different one. In an exemplary case, the signals may be compared by calculating their correlation and choosing the one that is more similar, particularly, that has higher correlation. Division is needed to further scale the resulting sub-areas. In an exemplary embodiment of the present invention, scaling is needed to make the stimuli displayed after division large enough so that they could be used, taking into account the BCI limitations. Such limitations may include stimulus area (particularly, minimum area), stimulus volume (for 3D stimuli), blinking rate, brightness, angular diameter, etc.

Please note that many BCIs require high level of synchronization between frames that the user sees on screen and data received from biological data reading devices (e.g. EEG readers, which are examples of modules 120 and 150) to operate. For instance, for CVEP to operate correctly, it may require less than 8 msec synchronization precision. To achieve this, the disclosed system may include a sensor that reads the current screen state and sends this information to the computing device. Specifically, this may be a photometric sensor measuring brightness levels of the screen and its parts. In an exemplary case, the sensor may be placed on a special screen area that changes its brightness according to a specified rule. By synchronizing this rule with the stimulus display rule, particularly, it is possible to solve the problem of synchronization.

In an exemplary embodiment of the present invention, it is possible to divide the area O completely, including those sub-areas, where the command cannot be performed at all. Also, it is possible to use BCIs operating table-based stimulus environments, such as CVEP, some embodiments of SSVEP or P300, or other systems, means, interfaces, etc., which may be used instead of or along with a BCI. For instance, such BCIs are capable of further improving speed and accuracy of the present invention thanks to a higher number of stimuli that are presented simultaneously and higher speed and accuracy.

Also, in order to perform and/or render said division, various algorithms for constructing lines, geometric shapes, images (both vector and raster), 3D models, planes, zones, etc. may be used. For instance, Bezier curves may be used to create and/or render (display) sub-areas 767A . . . 767Z resulting from subdivision. In an exemplary case, first, at least one GUI area (particularly, the entire GUI) is subdivided, which is shown, e.g. in FIG. 7.

Also note that the described subdivision may take into account graphic elements, including GUI elements, menus, panes, etc. that are located (particularly, displayed) on the computing device screen. For the purposes of subdivision, the location of at least one element may be obtained, e.g. from operating system services of the computing (electronic) device. The methods of obtaining such locations may include, for instance, obtaining coordinates of said elements. Said locations may be used for division, particularly, to generate the division grid. Also note that said elements may include icons, buttons, elements of applications, application windows, menus, panels, etc. Also note that the locations (as well as borders, coordinates, screen positions, etc.) of described menus, panels, graphic elements, etc. may be determined by said means or other methods, wherein both locations and other parameters of (graphic) elements may be used for the purposes of subdivision. Also, various APIs (Application Programming Interface) may be used, such as operating system APIs, particularly, Windows API, etc. Specifically, Microsoft UI Automation can be used to do the above. Therefore, particularly, division may be made in such a way, so that at least one resulting sub-area contains at least one GUI element or a menu that does not outstretch beyond this sub-area. Borders and locations of the described elements may also be determined by other methods, including applications, extensions, etc. that are capable of locating elements, particularly, on the screen, e.g. in application windows, on the desktop, in the menu, panels, etc.

As mentioned above, at least one sub-area that results from the GUI area subdivision may be assigned at least one stimulus that may be presented to the user, particularly, displayed (rendered) to the user. Such stimulus may be displayed either over (inside) or near at least one of such sub-areas. At the same time, said stimuli (particularly, one or more stimuli) may occupy the entire sub-area that results from the subdivision of some area, or at least one part thereof.

In an exemplary case, a stimulus may be displayed in any area of the screen that contains the GUI, as well as on another screen/device. In an exemplary case, such device may be an additional translucent screen positioned on top of the main screen that is used to display stimuli on top of main screen areas.

The stimuli described in the present disclosure may be displayed on a separate layer. Please note that stimuli may be displayed to the user either on top of at least one GUI element, behind that element, or they may be parts of that element.

In an exemplary case, interaction between the present system and the BCI may look as follows:
the currently active area is divided into k areas of smaller size (sub-areas);
the resulting sub-areas are assigned unique identifiers (id_i);
the global screen coordinates for stimuli (coord_i), which may be located inside the resulting sub-areas, are calculated;
at least one query is sent to the BCI: “to display stimuli corresponding to id_1, id_2, . . . , id_k at coordinates coord_1, coord_2, . . . , coord_k and to recognize the stimulus that the user is focusing on”;
the present BCI system selects the stimuli to be displayed (rendered, presented, etc.) for given id_i;
the selected stimuli are displayed in the given coordinates;
the target stimulus is recognized by means of the present system, particularly, the BCI;
the present system (with the BCI) calculates/determines the id_i corresponding to the target stimulus;
if the sub-area corresponding to the id_i is not enough to determine the user's intention, then the process returns to the first step, but with the sub-area corresponding to the id_i becoming the currently active area;
otherwise, the command is performed in the sub-area corresponding to the id_i.

Please note that the description above describes one possible implementation of the present method. In an exemplary embodiment of the present invention, the disclosed system and method (or at least one part thereof) may be joined with other interfaces, as well as with a BCI in order to create a united system, which, in an exemplary case, allows to avoid using another application that is located on top of all other application windows (see below).

Also note that, in the present disclosure, a BCI is capable of recognition as described, wherein the area subdivision and displaying of sub-areas may be performed by at least one other module of the present system, such as the computing device 130.

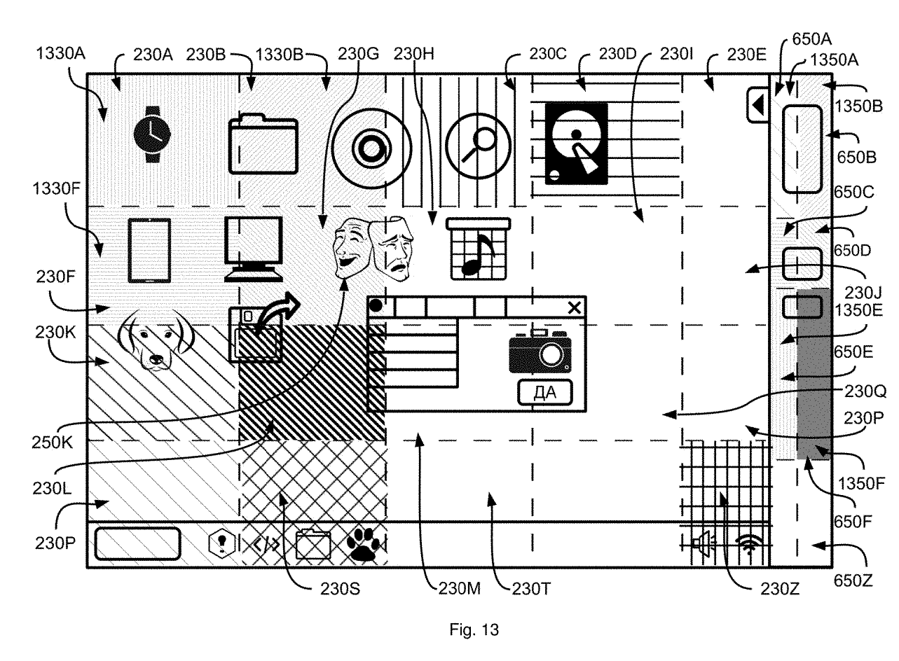

Stimulus presentation may be optimized with the transparency attribute, particularly, stimulus transparency, wherein transparency may be either partial or full, e.g. when the stimulus adopts one of its states. This approach, in an exemplary case, allows the user not to lose the context of the GUI. A stimulus may be transparent or translucent/half-transparent (an exemplary stimulus 1350F is shown in FIG. 13 that illustrates an exemplary way of stimulus presenting according to an exemplary embodiment of the present invention) all the time. Transparency also may depend on time and stimulus states. Transparency value may range from zero transparency (opacity) to full transparency. For instance, when a stimulus is presented, that e.g. is switching between black and white states (specifically, colors), the white state may be opaque. At the same time, its black state may have a high degree of transparency, e.g. 60-90% transparency, where 100% is full transparency.

In an exemplary embodiment of the present invention, the intensity of the light (e.g. light emitted by the computing device screen, particularly, by a stimulus) that excited the retina is a pivotal characteristic for a BCI. In exemplary case, the stimulus area and its brightness amplitude, e.g. when switching from black to white (which is an example of blinking), from gray to white, from light gray to black, from black to gray, from yellow to green, from red to white, etc. are pivotal characteristics for a BCI.

After the stimuli have been presented to the user, the target stimulus Sj is identified, particularly, by means of input and/or registration devices/modules, such as a BCI. Please note that the method described here may be used along with other methods for user interaction with the interface or system modules, including (data) input devices/modules, such as registration modules 150, and computing devices/modules 130, displaying modules 140, data processing modules 120, etc., and this method is not limited to BCIs. For instance, in order to identify the target stimulus Sj, voice commands (that are registered by a microphone) may be used, as well as a mouse, eye trackers or any other system, method, or device capable of recognizing the user's intention and selecting of at least one command

Please note that stimuli presented to the user may be of any geometric shape, or they may be of the same shape as division grid, and/or the may be of different shapes, and/or they may be located on several sub-areas, and/or they may be located on at least one part of at least one sub-area, etc. For instance, as mentioned above, stimuli may cover entire sub-areas, as shown in FIG. 13, in which exemplary stimuli 1330A, 1330B, 1330F are stimuli for corresponding sub-areas 230A, 230B, 230F, while exemplary stimuli 1350A, 1350B, 1350E, 1350F correspond to sub-areas 650A, 650B, 650E, 650F, etc. In this case, dashed lines of stimuli are used to better show how these stimuli are placed and where their borders are, and are not the actual representation of said stimuli. As mentioned above, stimuli may have different appearance, colors, shapes, transparency, etc., and also these parameters may change over time. For instance, in the CVEP method, the blinking rule for each stimulus is defined by a 0-1 sequence, where “1”s mean that the stimulus will be black for the next, say, 0.1 sec, and “0”s mean that the stimulus will be white in the next period of time.

Stimuli may also be various images of various shapes, images that may have varying states, e.g. color, blinking frequency, shape, position on screen, etc. A stimulus may also be a combination of several such images.

According to an embodiment of the present invention, it is also possible to perform commands after the target stimulus has been identified (or during the identification). A command may be an instruction to any module of the present system, GUI, operating system, input devices, BCI, etc. Such commands may include mouse clicks, mouse button holds, cursor movement, mouse dragging, mouse wheel clicks, starting/closing/minimizing an application, (graphic) button pressing, application window or icon movement, computer shutdown, switching between applications and other actions performed by the user, a module of the present system, a computing device, an application, a component, an element installed onto/into the modules of the present system, or an add-on module/device, etc.

Commands may also be complex, combining several commands, which would require one or several stimuli to be (sequentially) identified in order to work. Drag-n-drop is an example of such command, which specifically involves pressing a mouse button, then moving the mouse with the button held, and then releasing the button. To perform this command, a separate identification of mouse button hold and release may be required.

Please note that the command mentioned above may realize at least one part of the present invention, e.g. it may instruct the system to perform scaling (see below).

In an exemplary case, the user may be offered to select from a pre-determined set of commands and/or to create their own instructions, e.g. by means of a menu, particularly, a side-bar menu. Such menu, for instance, may include elements to select and/or set up the described commands performed when a corresponding stimulus is being identified. A menu may include a list of instructions, in which the instructions that may be performed by the user or at least one of the modules of the present system are determined either by the user or the modules of the present system, e.g. instructions for using functions provided by at least one input device, BCI, interface, etc.

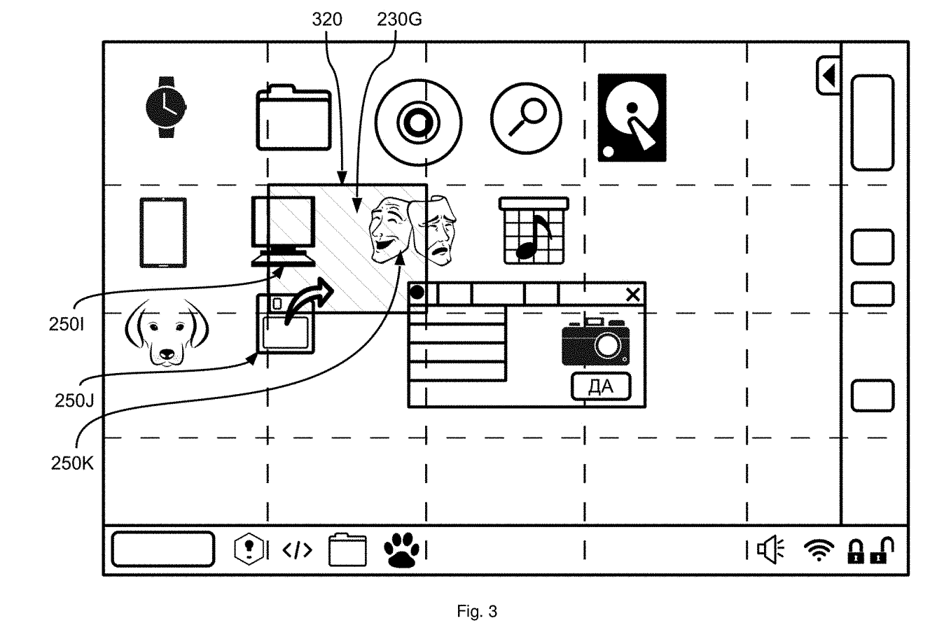

FIG. 3 shows an exemplary GUI with the target stimulus 320 that has been identified for a corresponding sub-area 230G in an exemplary embodiment of the present invention.

In an exemplary case, if the sub-area corresponding to the identified stimulus is enough to precisely determine the user's intention, then the corresponding command is being performed in this sub-area. The command may be performed, e.g. by a computing device or an application. In order to determine whether the current sub-area is enough, one of the following methods may be used, including, but not limited to:
the (minimum) size of such sub-area may be (initially) determined, e.g. by the user, an application, a system module, etc., in a specific embodiment of the method or for a specific GUI. For instance, if all GUI elements that may be interacted with through commands are larger than 2 cm, then subdividing the GUI into sub-areas (particularly, cells, blocks, etc.) of 1 cm may be considered enough. Also the system, e.g. at least one module thereof, may be instructed by an application and/or the user to perform scaling until the current sub-area is of a specified/pre-determined size, e.g. of 2 mm;
an additional step may be added as well, where the user will have to confirm that the current sub-area Oj is enough. For instance, such additional step may be implemented via a menu, or at least one element thereof. Such menu may be either pop-up or stationary, so that the user is able to interact with it at any time. The menu may be displayed in a specially designated part of the screen. The menu may use BCI functions, i.e. the user may interact (specifically, by focusing) with at least one menu button either instead of choosing another sub-area or while choosing one. Menu buttons may have various functions, such as “Stop” (or “Enough”), “Yes”, “No”, “More”, “Scale”, “Cancel”, “Back”, “Zoom in”, “Zoom out”, “Mouse click”, “Mouse button hold”, “Mouse button release”, “Mouse button press and hold”, “Move the window”, “Move the mouse”, “Minimize the window”, “Leave the system”, “Close”, “Call a specialist”, “Make a call”, “Open and additional menu”, “Re-divide the (GUI) area”, “Change the division grid step”, “Change the stimulus color”, “Change the stimulus blinking rate”, “Make stimuli smaller”, “Change the stimulus size”, “Change the division parameters”, etc. Buttons may be placed into such menu, e.g. while an application, filter, service, etc. performs the present invention.
a command performed in any point O yields the same result in the GUI;
a sub-area with the size of 1 px of the GUI is considered to be enough to perform a command

Please note that, in an exemplary case, after the sufficient area has been determined, the previously set command may be changed. In an exemplary case, a new command is selected depending on the current area.

If the sub-area corresponding to the stimulus is not enough to determine the user's intention, then it is scaled (particularly, enlarged) and further subdivided into sub-areas that are then assigned stimuli as already described in the present disclosure. After this scaling, the user may interact with newly defined sub-areas. At the same time, before the scaled sub-area is displayed, previously displayed stimuli may be hidden. Thus, an exemplary embodiment of the present method comprises hiding stimuli, scaling the current sub-area, dividing it into new sub-areas, assigning stimuli to sub-areas and displaying those stimuli.

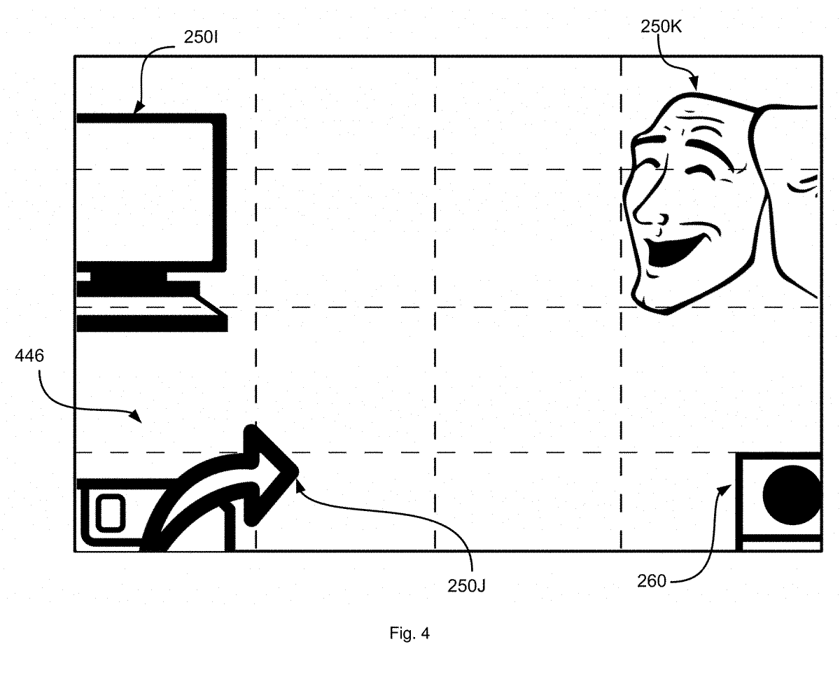

In an exemplary case, the scaling may be performed until the currently active area is enough to precisely determine the user's intention, as shown, e.g., in the sequence of drawings FIG. 2->FIG. 3->FIG. 4.

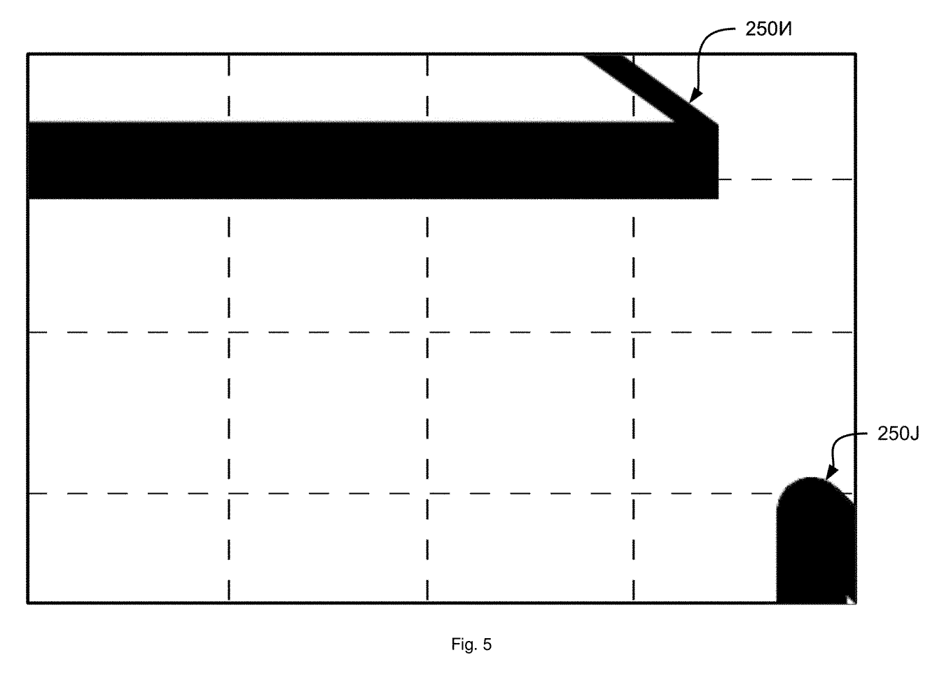

FIG. 4 shows an example of displaying of the sub-area 230G after scaling, wherein the menu and bottom panel are hidden, in an exemplary embodiment of the present invention. Please note that at least one element displayed to the user and related, e.g., to the menu 240, a panel (e.g. a bottom panel 284), the GUI menu (640 in FIG. 6), application window 260, may be hidden (as shown in FIG. 4) and/or displayed unchanged after the sub-area has been scaled (284, 240 in FIG. 6), and/or scaled along with said sub-area (250I, 250K, 250J, 260 in FIG. 4, 250I, 250J in FIG. 5, 260 in FIG. 6). In an exemplary case, the elements displayed to the user may overlap other GUI elements after the sub-area has been scaled (284, 240 in FIG. 6).

FIG. 5 shows another example of scaling of the sub-area 446 (see FIG. 4) in an exemplary embodiment of the present invention.

FIG. 6 shows an exemplary GUI area with division and the menu, particularly, a side-panel menu, also divided, in an exemplary embodiment of the present invention.

Please note that the described scaling may be performed not only for the sub-area corresponding to the identified stimulus, but also for at least one other sub-area or its part. For instance, if the sub-area 230G (FIG. 2) corresponds to the identified stimulus, it may be scaled along with at least one other sub-area, e.g. an adjacent or nearby one, such as 230A and/or 230B, and/or 230S and/or 230H, and/or 230M. Please note that in an exemplary case, a group scaling of several areas at once may be performed as scaling of a single area. For instance, the group/set of sub-areas 230G and 230A and/or 230B, and/or 230S, and/or 230H, and/or 230M, and/or 230L, and/or 230F taken together may be scaled as a GUI area spanning all these sub-areas.

In an exemplary case, the group scaling of the sub-area corresponding to the target stimulus along with neighboring sub-areas provides additional benefits to the user, the benefits including an ability to select graphic elements located on or across the border of some sub-area, or in close vicinity to said border.

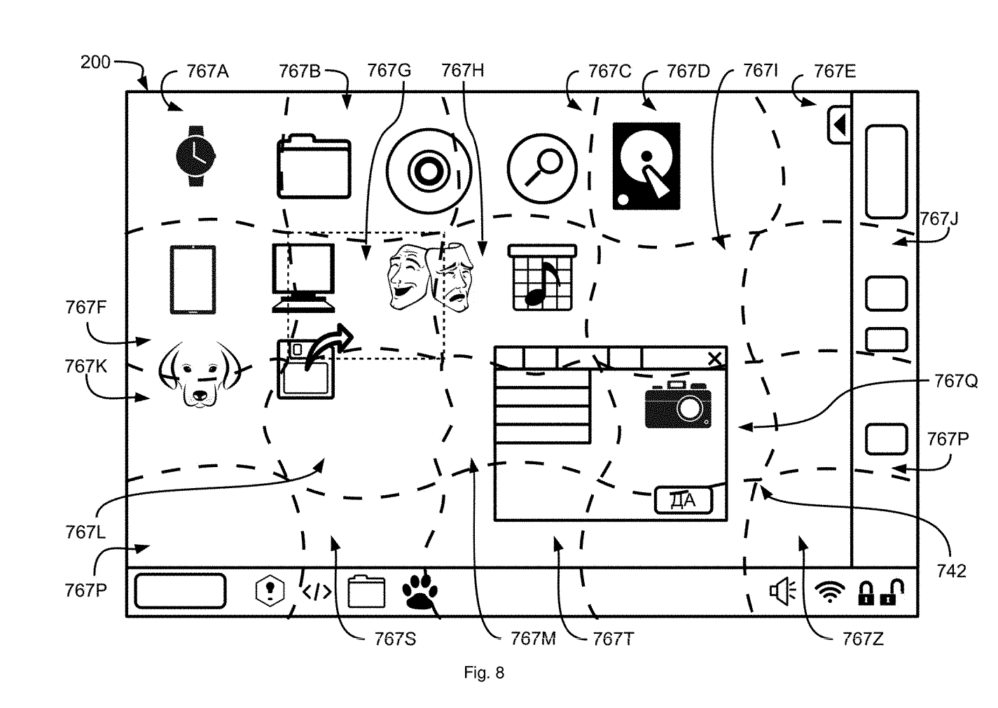

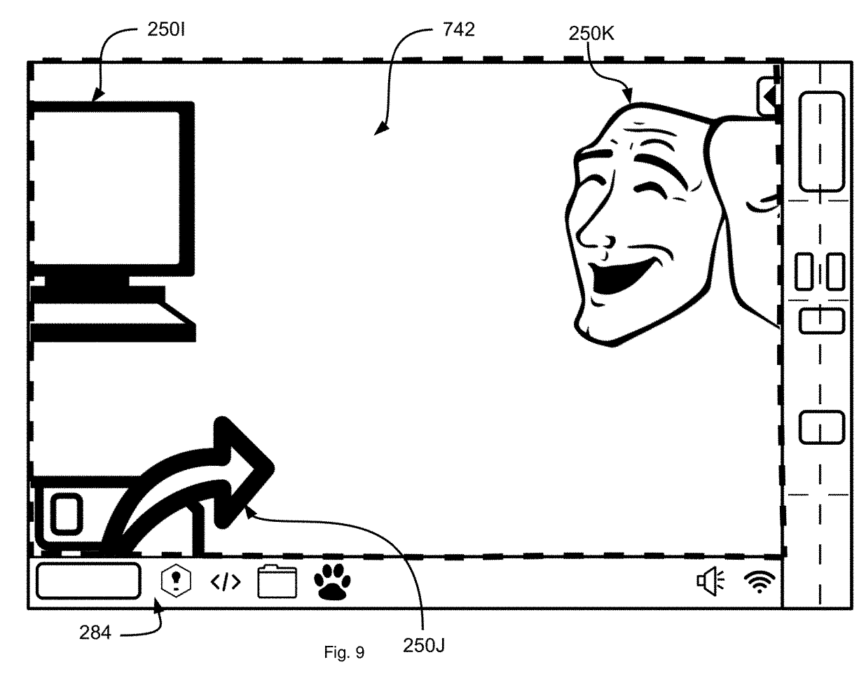

Also note that, after non-rectangular division, e.g. curvilinear division (see FIG. 7), one sub-area may be scaled with its neighbors. FIG. 8 shows an example of non-rectangular division with exemplary sub-area borders that will be displayed after the sub-area 767G has been identified, according to an exemplary embodiment of the present invention. An example of display of the scaled sub-area 767G is shown in FIG. 9. Thus scaled sub-area may also be further divided as disclosed herein, particularly, along a rectangular or curvilinear grid, etc.

FIG. 9 shows an example of display of the scaled sub-area 767G and adjacent sub-areas in an exemplary embodiment of the present invention.

Also note that the division disclosed herein may be irregular, i.e. total areas of sub-areas may differ, as well as their geometric shapes. Therefore, the division grid (e.g. 285, 742, etc.) may also be irregular. For example, spacing between horizontal lines of the division grid may differ, as well as its vertical spacing, or spacing between other lines.

Please note that the parameters of said division may be changed (either by the user or by a module of the present system), e.g. during scaling. For instance, division parameters may include the number of sub-areas, their sizes and areas, division grid spacing, shape of division lines, division algorithm (method), etc. In an exemplary case, said parameters may differ from those used in the previous scaling. Please note that the user or at least one module of the system of the present invention may change division parameters “on the fly”, i.e. immediately before the sub-area is scaled or immediately after this. Thus, division parameters (and, therefore, division itself) may be changed after the preliminary division. In an exemplary case, division parameters may be changed to place stimuli at more exact locations and to improve the user's interaction with GUI elements.

Please note that scaling may be performed in various ways and by various means. In an exemplary embodiment of the present invention, scaling may be performed by saving the image of the displaying module (particularly, a monitor screen) or a part thereof, and then by displaying it as a scaled sub-area. For instance, the image of at least one GUI area may be saved by means of a screenshot of the entire screen or at least one part thereof. Otherwise, scaling may be performed with the “screen magnifier” software that allows to scale parts of the displayed image, particularly, in the displaying module 140.

Also note that the described scaling may also involve means of image processing and/or editing, and/or (quality) enhancement, as well as filters, functions, methods, including graphic cards, drivers, various conventional algorithms, etc. that allow to scale images without distorting them. The means mentioned above may include algorithms of screen glare suppression, noise removal, medial filters, midpoint filters, ordering filters, adaptive filters, Roberts filter, Prewitt filter, etc.

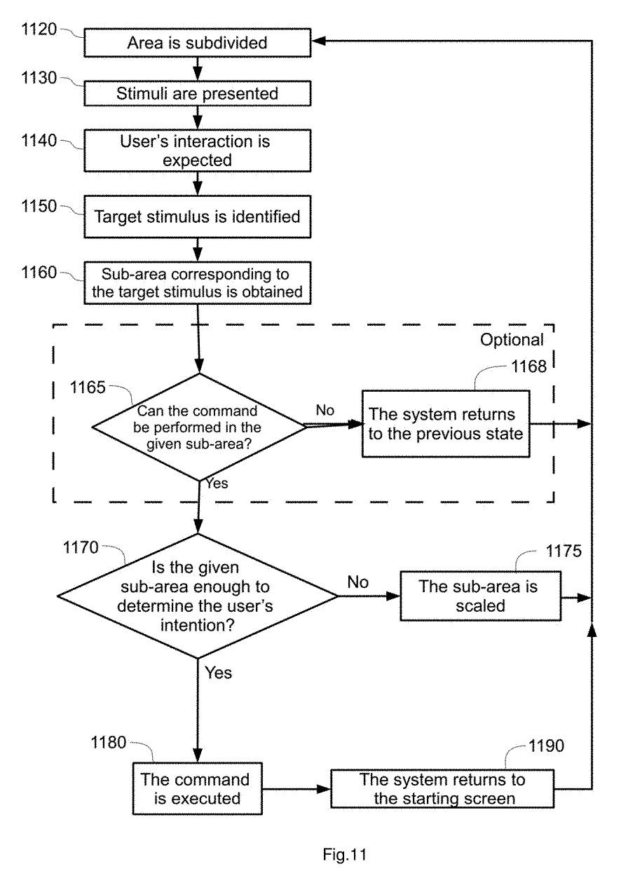

FIG. 11 shows an exemplary method of the present invention. Please note that the steps shown in FIG. 11 may be performed by at least one of the modules of the system as disclosed herein. In step 1120, the area is subdivided into sub-areas as described in the present disclosure. Then, in step 1130, a stimulus is presented, and then, in step 1140, the user's interaction with the stimulus is expected. Then, in step 1150, the target stimulus is identified. Then, in step 1160, the sub-area corresponding to the target stimulus is obtained. Then, optionally, in step 1165, it is checked whether it is possible to perform the command in the given sub-area, and if yes, then, in step 1170, it is checked whether the given sub-area is enough to precisely determine the (user's) intention. If in step 1165 it has been found that the command cannot be performed, then the algorithm performs step 1168, in which the system is returned to its previous state, e.g. a previous screen, a previous GUI state, a previous sub-area, etc. and then the step 1120 is performed again. In an exemplary embodiment of the present invention, the optional steps 1165 and 1168 are performed, e.g. when the potentially available area for performing the command, as described herein, is not in use.

If in step 1170 it has been found that the sub-area is enough to precisely determine the user's intention, then, in step 1180, the command is performed, and after that, in step 1190, the screen is returned to its basic state (initial screen), and the algorithm returns to step 1120. If in step 1170 it has been found that the sub-area is not enough to precisely determine the user's intention, then, in step 1175, said sub-area is scaled and further displayed, and the algorithm returns to step 1120.

In an exemplary case, some small pauses may happen between the steps of the present method, or the iterations of the present method, or any operations of the system, in order to enhance the convenience of the system. These pauses may help the user to better navigate through the dynamically changing GUI, as well as may provide more time for the user to think through and plan their actions.

As mentioned above, one of the exemplary embodiments of the present invention is at least one application (or a part thereof, a program module of the application, a program code, a service, a driver, etc.) that controls the user's PC (computing/electronic device). An exemplary interface is a GUI (Graphic User Interface), particularly, an operating system GUI. For instance, said application may be run on a PC, e.g. above at least one application window or all application windows (on the topmost layer), including the GUI elements. Also, in one of exemplary embodiments of the present invention, such application may be embedded into the operating system, the desktop shell, interfaces, including GUIs, or it may be a filter that may be embedded (by software means) into at least one application, operating system, desktop shell, interface, etc., wherein such filter and/or application may intercept data, e.g. instructions and/or commands, including those of the operating system, the GUI, drivers, services, etc.

In an exemplary case, the user solves the task of making a left mouse click (command) over some GUI element.

The BCI stimulus system may be implemented as CVEP, a table-based stimulus environment (e.g. an 8×4 stimulus table), which in some embodiments requires about 1-2 secs to recognize a stimulus from the set. To perform a command, particularly, a left mouse click in an initial area O, which is, in an exemplary case, equal to the entire GUI or at least a part of it that, e.g. excludes the menu area, said area O is subdivided in to sub-areas O1, . . . , O32, where 32 is the number of elements in an 8×4 table. In an exemplary case, these sub-areas form an 8×4 table as well.

In an exemplary embodiment of the present invention, scaling may be skipped, particularly if the sub-area is large enough for the system to operate correctly. Then, stimuli are presented, with (partial) transparency, in an exemplary case. Then, the target stimulus is identified and the corresponding sub-area O1 . . . O32 (hereinafter referred to as area A) is obtained. If the obtained sub-area A is not enough to determine the user's intention, e.g. if it contains several different control elements, such as icons/shortcuts, then this sub-area may be scaled until it fills full screen to perform the given command, particularly, one initially selected. Then, the area A is divided into sub-areas A1, . . . , A32, where the stimuli are presented, the stimuli being (partially) transparent, in an exemplary case. Then, the target stimulus is identified, and a corresponding sub-area is obtained from A1-A32 (herein after referred to as area B). If the obtained sub-area B is enough to determine the user's intention, it may not be further scaled, and stimuli may no longer be presented, while the command can be performed in this sub-area. Therefore, the application performs the needed action (in this case, a left mouse click) in the sub-area B, particularly in its center.

In an exemplary embodiment of the present invention, when precision and performance characteristics of the CVEP stimulus environment are taken into consideration, an additional feature may arise, specifically, increased speed and precision of GUI control compared to counterparts. Let the area be enough if its height is no more than 10% of the screen height, and its width is no more than 10% of the screen width. Then the total time required to find the needed area equals the time required to perform two steps described above (wherein each step may include scaling of some area and/or dividing of an area, and/or presenting of stimuli, and/or identification of the target stimulus), i.e. about 3 secs. One target stimulus can be identified using the CVEP method with reliability of 98%. Therefore, the reliability of inputting two target stimuli in a row is approximately 96%.

Similarly, to perform a command in the sub-area occupying, e.g. 2% of the GUI vertically and horizontally, it may require 3 steps mentioned above, i.e. almost 4-5 secs. The reliability of inputting three target stimuli in a row is approximately 94%.

Please note that the BCI performance speed (bitrate) may be measured in bits/sec, where X bits/sec means that the system may choose among 2̂(X*N) options maximum in N secs. With CVEP, bitrate may be up to log 2(32)=5 bits/sec, at a high reliability. With SSVEP, bitrate may be up to log 2(40)˜=5.3 bits/sec. Please note that SSVEP has almost the same reliability as CVEP.

One of the embodiments of the present invention is the system for controlling the PC GUI. Such system may comprise a module for displaying and recognizing stimuli—a central module—and applications that communicate with this module, e.g. via the API described below. For example, such applications may include virtual mouse and virtual keyboard. In an exemplary case, the central module may comprise a menu, similar to the one described above, particularly, a sidebar-menu. The central module may comprise a recognition system (particularly, a BCI), which operates as described above, in an exemplary case.

In an exemplary embodiment, the central module may provide a way for interaction to third-party systems and applications, e.g. by providing an API to them. In an exemplary case, the central module may provide the following functions for third-party applications: “to register the set of areas received from a third-party application that can be currently interacted with by the user”, “to find out with which registered area the user wants to interact”, “to find out how sure the central module is in the user's intention to interact with a given area”, etc.

To implement the central module, the ability to create a full-screen application with a transparent background (layer) that virtually overlays other windows (is located on the topmost layer) and is transparent for mouse events. These functions may be provided using WinAPI or third-party libraries. For example, in Qt5 framework it can be achieved by creating a window with Qt::WindowFullScreen state, setting Qt::WindowTransparentForInput and Qt::WindowStaysOnTopHint flags, and setting its color to Qt::transparent. For the central module to place the stimuli correctly, third-party applications may describe the provided areas using global screen coordinates.

For instance, in an exemplary case, the virtual keyboard, which may be included into the present system in one of its embodiments, may communicate with the central module in the following way:

a) the keyboard “registers” areas containing currently displayed and available keys (particularly, a standard QWERTY set of keys) via the API;

b) the central module displays a GUI area that contains the keyboard, with sub-areas comprising those areas that have been registered by the keyboard;

c) the central module determines the user's intention to interact with one of the areas that have been registered by the keyboard and sends a corresponding signal to the keyboard;

d) the virtual keyboard receives that signal and performs the needed actions (e.g. emulates pressing of the key and/or changes the current layout), then it defines new interaction areas (a new set of keys), and the process returns to step a).

Please note that, in an exemplary case, the areas that are registered by the virtual keyboard are enough and therefore are not scaled.

Also note that in an exemplary embodiment the central module may simultaneously communicate (process queries, recognize and present stimuli, etc.) with several other systems and/or modules using the method described above. For instance, in step b) with virtual keyboard embodiment, along with areas registered by the keyboard, other areas registered by other applications may be also displayed. At the same time, in an exemplary case, in step c) the central module may determine which of the third-party systems and/or modules has registered the area of the interface that the user wants to interact with. An example of simultaneous communication may be processing of third-party application areas (e.g. virtual keyboard areas) and central module menu areas.

Please note that in an exemplary case, in step c) the central module may reply not with the single recognized “most likely” area, but with a probability of the user choosing each area that have been registered by said application (e.g. 0.5 probability for area O1, 0.2 probability for area O2, etc.). In an exemplary case, the application may choose the form of reply: either a single area or a set of probabilities for all areas. Please note that, in an exemplary case, the application may inquire to periodically receive the given probabilities from the central module (e.g. every 0.1 sec). In an exemplary case, this approach may extend the capabilities to control the GUI or individual applications.

In an exemplary case, the central module may provide functions to interact with the menu that may be optionally included into the module. In an exemplary case, the application may register its own commands and instructions in the menu and set their appearance (e.g. text or icon) through API. The central module will, in turn, place the menu elements corresponding to those commands using the appearance parameters set by the application, and if such element is identified, the module will send a signal to the application notifying it of which command or instruction has been recognized.

For instance, the virtual mouse application may register its “left mouse click” command in the central module and can be called, when the central module has identified this command. In an exemplary case, the virtual mouse may operate using the area-locating method described above, to locate the area that is enough to perform the command (e.g. a left mouse click). That is, the virtual mouse may divide the entire desktop (excluding the menu, in an exemplary case) into sub-areas along a 2D rectangular grid, send the resulting sub-areas to the central module for recognition, receive a reply from the central module (in the form of a recognized sub-area), scale said sub-area until it fills the size of the currently active area, then divide the scaled sub-area, send new resulting sub-areas to the central module, receive another reply, etc., until the system obtains a screen area that is enough to perform the command. After that, the command is performed.

In an exemplary case, the GUI area containing the central module menu cannot be scaled by the virtual mouse.

In an exemplary embodiment of the present invention, mouse clicks may be emulated in the Windows operating system through WinAPI using the following commands:

### SetCursorPos(X,Y);

mouse_event(MOUSEEVENTF_LEFTDOWN,X,Y,0,0);
mouse_event(MOUSEEVENTF_LEFTUP,X,Y,0,0);
where X and Y are the screen point coordinates, where the click is expected to be performed.

Please note that keyboard key pressing may be also emulated with WinAPI.

Also note that instead of or in addition to said stimuli, the system may use internal and external states of the user, such as “I'm relaxed”, “I'm angry”, “I blinked”, “I think I'm closing my right hand”, etc. In other words, BCIs that are capable of processing such user's states may be used, particularly, in order to determine whether the user interacts with the present system or at least one of its modules.

Also note that the method of the present invention may be used with any input device, as well as with a BCI. For instance, if voice commands are used instead of a BCI, the speech recognition system responsible for sub-area recognition may mark each of, say, 100 available sub-areas with a number from 1 to 100 (either instead of or in addition to corresponding stimuli). When the user says “42”, the speech recognition system recognizes it and sends the result into the system of the present invention, which, in turns, divides the area, scales the corresponding sub-area, etc. If the eye tracking system is used, then the present system sends sub-area IDs and their coordinates there. The eye tracking system recognizes the larger sub-area that the user looked at, wherein the stimuli may be not displayed. Then, the process returns the ID, scales the sub-area, etc.

In an exemplary embodiment of the present invention, when an input device is used, such as a mouse manipulator, a stylus, a joystick, etc., when the user struggles to point at a particular spot (e.g. if the user has Parkinson's disease), therefore, the objective is to point at a larger area, then in one embodiment, a mouse click inside a sub-area may be considered the same as selecting that sub-area. That is, instead of waiting for the recognition algorithm to work, the click may be performed, particularly, if the user is capable of such action. In this case, the application that operates mouse clicks is an application with a trivial recognition system/means described in the present disclosure.

Please note that in the described embodiments of the present invention, it is still possible to select given sub-areas with input devices. Such input devices may be a mouse manipulator, a touchscreen, or a keyboard. A signal received from an input device may interrupt the stimulus recognition by a BCI and substitute it with, e.g. at least one of the described commands and/or actions, thereby starting a new iteration of the user-interface interaction described herein. Please note that user-interface interaction may be emulated by virtual devices or instructions/commands of operating system, applications, etc.

Please note that the present system and method enable the user to control an electronic (computing) device, including a computer, an arbitrary GUI, etc. with one or several means, such as BCIs, eye-trackers, etc.

In an exemplary embodiment of the present method based on a BCI, the API described above, and virtual keyboard and virtual mouse applications, the resulting system enables the user to contactlessly control the GUI of a PC in a comprehensive way, just like interacting with that interface using conventional mouse and keyboard.

Please note that the proposed method that includes giving API to third-party applications allows to design systems adapted to control any GUI.

Please note that the proposed method that includes giving API to third-party applications allows to solve various user problems with high speed and reliability. In an exemplary case, such problems may be solved by designing separate applications for specific problems that use API to interact with a central module according to the method described above. For instance, a video player application may be designed for watching movies. This application may register its “start playback”, “pause” and other buttons in the menu of that central module.

FIG. 12 shows various exemplary embodiments of the system to carry out the method of the present invention. Please note that the modules pf the present invention described herein may be either interconnected or incorporated into each other. For instance, the module 1210 in FIG. 12B may comprise the modules 120A and 130A, i.e. it may, in an exemplary case, act as the modules 120A and 130A.

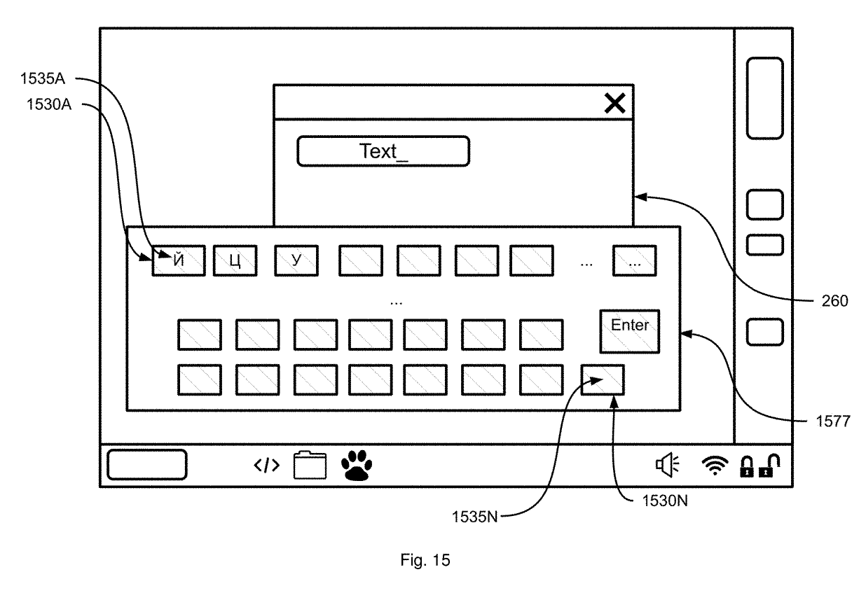

FIG. 15 shows another example of giving stimuli according to an exemplary embodiment of the present invention. The elements 1530A . . . 1530N are keys of the virtual keyboard 1577 that has been described in more details above. Please note that at least one virtual keyboard element (1530A . . . 1530N) may be assigned (associated with) a stimulus (1535A . . . 1535N), as shown in FIG. 15.

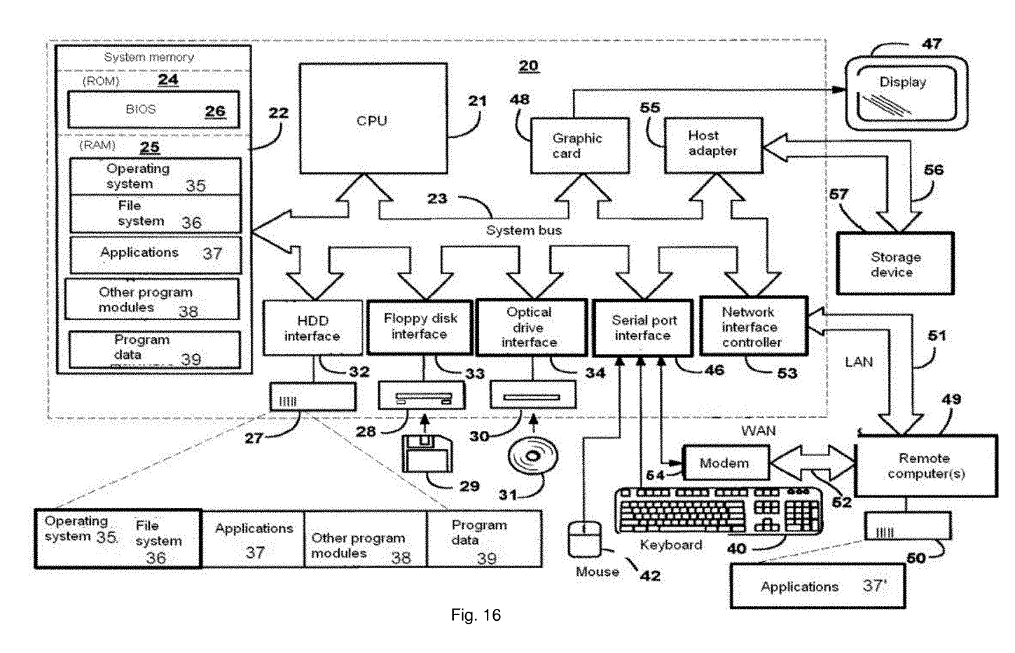

FIG. 16 shows an exemplary general-purpose computer system comprising a multi-purpose computing device—a computer 20 or a server comprising a CPU 21, system memory 22 and system bus 23 that connects various components of the system to each other, particularly, the system memory to the CPU 21.

The system bus 23 can have any structure that comprises a memory bus or memory controller, a periphery bus and a local bus that has any possible architecture. The system memory comprises a ROM (read-only memory) 24 and a RAM (random-access memory) 25. The ROM 24 contains a BIOS (basic input/output system) 26 comprising basic subroutines for data exchanges between elements inside the computer 20, e.g. at startup.

The computer 20 may further comprise a hard disk drive 27 capable of reading and writing data onto a hard disk, a floppy disk drive 28 capable of reading and writing data onto a removable floppy disk 29, and an optical disk drive 30 capable of reading and writing data onto a removable optical disk 31, such as CD, video CD or other optical storages. The hard disk drive 27, the floppy disk drive 28 and optical disk drive 30 are connected to the system bus 23 via a hard disk drive interface 32, a floppy disk drive interface 33 and an optical disk drive interface 34 correspondingly. Storage drives and their respective computer-readable means allow non-volatile storage of computer-readable instructions, data structures, program modules and other data for the computer 20.

Though the configuration described here that uses a hard disk, a removable floppy disk 29 and a removable optical disk 31 is typical, a person skilled in the art is aware that a typical operating environment may also involve using other machine-readable means capable of storing computer data, such as magnetic tapes, flash drives, digital video disks, Bernoulli cartridges, RAM, ROM, etc.

Various program modules, including an operating system 35, may be stored on a hard disk, a floppy disk 29, an optical disk 31, in ROM 24 or RAM 25. The computer 20 comprises a file system 36 that is connected to or incorporated into the operating system 35, one or more applications 37, other program modules 38 and program data 39. A user may input instructions and data into the computer 20 using input devices, such as a keyboard 40 or a pointing device 42. Other input devices (not illustrated) may include microphone, joystick, gamepad, satellite antenna, scanner, etc.

These and other input devices are connected to the CPU 21 usually via a serial port interface 46, which is connected to the system bus, but can also be connected via other interfaces, such as parallel port, game port, or USB (universal serial bus). A display 47 or other type of visualization device is also connected to the system bus 23 via an interface, e.g. a video adapter 48. Additionally to the display 47, personal computers usually comprise other peripheral output devices (not illustrated), such as speakers and printers.

The computer 20 may operate in a network by means of logical connections to one or several remote computers 49. One or several remote computers 49 may be represented as another computer, a server, a router, a network PC, a peering device or another node of a single network, and usually comprises the majority of or all elements of the computer 20 as described above, though only a data storage device 50 is illustrated. Logical connections include both LAN (local area network) 51 and WAN (wide area network) 52. Such network environments are usually implemented in various institutions, corporate networks and the Internet.

When used in a LAN environment, the computer 20 is connected to the local area network 51 via a net interface or an adapter 53. When used in a WAN environment, the computer 20 usually operates through a modem 54 or other means of establishing connection to the wide area network 52, such as the Internet.

The modem 54 can be an internal or external one, and is connected to the system bus 23 via a serial port interface 46. In a network environment, program modules or parts thereof as described for the computer 20 may be stored in a remote storage device. Please note that the network connections described are typical, and communication between computers may be established through different means.

In conclusion, it should be noted that the details given in the description are examples that do not limit the scope of the present invention as defined by the claims. It is clear to a person skilled in the art that there may be other embodiments that are consistent with the spirit and scope of the present invention.

1. A method for contactless user interface, the method executable by a computer, the method comprising:
a) receiving at least one command the user intends to execute;
b) setting the visible GUI as the currently active area;
c) displaying said currently active area;
d) dividing said currently active area into a number of rectangular sub-areas equal to the number of available stimuli provided by the BCI;
e) displaying unique visual stimuli for each sub-area by means of the BCI;
f) identifying, by means of the BCI, the target stimulus corresponding to the sub-area, in which the user command is intended to be executed;
g) obtaining the sub-area corresponding to the target stimulus identified;
h) in response to the obtained sub-area being enough to determine the user's intention, wherein the conditions for specifying that the sub-area is enough to determine the user's intention include at least one of: the command, when executed in any point of the given sub-area, returns the same results; or the current size of the given sub-area corresponds to the minimum allowable size; or the current size of the given sub-area is 1 pixel:
executing the command in the obtained sub-area;
i) in response to the obtained sub-area being not enough to determine the user's intention:
increasing the scale and setting the obtained sub-area as the currently active area, then repeating the steps c-i.

2. A method for contactless user interface, the method executable by a computer, the method comprising:
a) obtaining at least two GUI sub-areas of arbitrary shape and size from a third-party application;
b) displaying at least one visual stimulus corresponding to at least one sub-area mentioned above to the user;
c) identifying at least one target stimulus corresponding to the sub-area, with which the user wants to interact;
d) obtaining a sub-area corresponding to the target stimulus;
e) notifying the third-party application that said sub-area has been identified.

3. The method of claim 1, wherein the area that is set as the currently active area is scaled.

4. The method of claim 2, wherein the target stimulus is identified by means of a BCI.

5. The method of claim 4, wherein BCIs based on CVEP, SSVEP or P300 are used.

6. The method of claim 4, further comprising voice commands registered by a microphone, and/or an eye movement tracking system, and/or a mouse, and/or a keyboard that are used to identify the target stimulus.

7. The method of claim 1, wherein each stimulus is routinely checked to measure the probability of it being the target stimulus.

8. The method of claim 1, wherein after the currently active area has been obtained, its sub-area borders are displayed.

9. The method of claim 1, wherein displayed stimuli are partially transparent.

10. The method of claim 1, further comprising giving sound and/or tactile stimuli to the user.

11. The method of claim 3, wherein at least one GUI element is not scaled along with the currently active area.

12. The method of claim 1, wherein the currently active area is divided into sub-areas following the lines of a rectangular or a curvilinear 2D grid.

13. The method of claim 1, wherein the currently active area is divided with respect to GUI elements located there, with which the user can interact.

14. The method of claim 2, wherein a menu is displayed to the user for obtaining and/or performing a command and/or confirming that the sub-area is enough and/or interacting with third-party applications.

15. The method of claim 14, wherein the menu is displayed separately from the GUI, it is not scaled and is always visible to the user.

16. The method of claim 14, wherein sub-areas corresponding to menu items are added to the sub-area obtained by dividing the currently active area or from a third-party application.

17. The method of claim 14, wherein the menu permits third-party applications to register their own elements and commands.

18. The method of claim 14, wherein the menu notifies the third-party application in case a menu sub-area that corresponds to an element or a command registered by the application has been identified.

19. The method of claim 14, wherein the menu is displayed after the sub-area corresponding to the target stimulus has been identified.
